(19) United States
(12) Patent Application Publication
(10) Pub. No.: US 2012/0281749 A1
(43) Pub. Date: Nov. 8, 2012

(54) ENCODER, DECODER, AND DATA CONFIGURATION

(75) Inventor: Tomohiro Ikai, Osaka-shi (JP)

(73) Assignee: Sharp Kabushiki Kaisha, Osaka (JP)

(21) Appl. No.: 13/520,747

(22) PCT Filed: Dec. 15, 2010
(86) PCT No.: PCT/JP2010/072579

§ 371 Date: Jul. 5, 2012

(30) Foreign Application Priority Data
Jan. 8, 2010 (JP) 2010-003392

(51) Int. Cl. H04N 7/26

(52) U.S. Cl. 375/240.02; 375/240.25; 375/240.01; 375/E07.027; 375/E07.076

(57) ABSTRACT

A moving image encoder (1) includes an encoding section (12) for encoding a symbol for the absolute value of each filter coefficient in a two-dimensional filter serving as an adaptive interpolation filter or an adaptive loop filter, the encoding section (12) encoding, in correspondence with the value of a symbol for which the encoding section immediately previously carried out the above encoding, the symbol for each filter coefficient sequentially from a filter coefficient close to or far from a central position in a two-dimensional placement of the filter coefficient set.

### TECHNICAL FIELD

The present invention relates to an encoder and a decoder each including an image filter for filtering an image.

### BACKGROUND ART

A moving image encoder is used to transmit or record a moving image efficiently. Specific examples of a moving-image encoding system include H.264/MPEG-4 AVC and a system being studied by the VCEG.

Non Patent Literature 1 discloses a filter called ALF (adaptive loop filter), which carries out a filtering process for reducing block distortion in a reference image. The ALF (i) selects, for each slice of a reference image, a filter coefficient that minimizes the difference between a reference image to which the ALF has been applied and a corresponding original image, and (ii) carries out a filtering process based on the filter coefficient.

Non Patent Literature 2 discloses a filter called AIF (adaptive interpolation filter), which carries out a filtering process for generating a highly accurate motion vector. The AIF (i) selects, for each slice of a reference image, a filter coefficient that minimizes the difference between a predicted image obtained by applying the AIF and a corresponding original image, and (ii) carries out a filtering process based on the filter coefficient.

The ALF and AIF, each of which selects a filter coefficient for each slice, each require the filter coefficient to be transmitted from an encoder to a decoder. It is thus important to reduce the amount of encoded data for filter coefficients in order to reduce the amount of encoded data to be transmitted.

Patent Literature 1 discloses a technique for reducing the amount of encoded data for filter coefficients to be transmitted to a decoder.

### CITATION LIST

Non Patent Literature 1
Block-based Adaptive Loop Filter, ITU-T Q.6/SG16 VCEG, VCEG-AI18, 2008

Non Patent Literature 2
Improved Filter Selection for B-Slices in E-AIF, ITU-T Q.6/SG16 VCEG, VCEG-AI38, 2006

Patent Literature 1
Japanese Translation of PCT International Application, Tokuhyo, No. 2008-536414 (Publication Date: Sep. 4, 2008)

### SUMMARY OF INVENTION

### Technical Problem

In the AIF and ALF, each of which carries out filtering for interpolation or correction of an image, such filtering involves a filter coefficient that tends to be (i) larger in absolute value for a position closer to a central portion of a filter reference region which is referred to during the filtering process and (ii) smaller in absolute value for a position farther from a central position of the filter reference region. Further, adjacent filter coefficients tend to be close to each other in value.

A filter coefficient is likely to be shared for each slice, and is thus placed, as illustrated in FIG. 23, in not a data section but a header section. Information placed in the header section is related to the entire slice, and is high in importance. Thus, encoding is generally carried out by an encoding system that is high in error tolerance and low in compression ratio (that is, an encoding system other than arithmetic coding).

The above conventional arrangement, in the case of encoding individual filter coefficients, encodes each filter coefficient regardless of the value (absolute value) of a filter coefficient encoded earlier, and thus fails to utilize the correlation between filter coefficients. The above conventional arrangement thus problematically fails to sufficiently reduce the amount of encoded data for filter coefficients.

The present invention has been accomplished in view of the above problem. It is a main object of the present invention to provide an encoder that can effectively reduce, as compared to conventional art, the amount of encoded data for filter coefficients to be transmitted to a decoder.

### Solution to Problem

In order to solve the above problem, an encoder of the present invention is an encoder for carrying out compression encoding of a filter coefficient set including at least a part of filter coefficients included in a two-dimensional filter for use as an adaptive interpolation filter or an adaptive loop filter, the encoder including: sorting means for sorting, in an order corresponding to a distance from a central position of the two-dimensional filter, the filter coefficient set arranged in a predetermined order; and encoding means for encoding the at least a part of filter coefficients in the filter coefficient set sequentially from a filter coefficient most preceding in the order as sorted.

Filter coefficients included in a two-dimensional filter for use as an adaptive interpolation filter or an adaptive loop filter have respective absolute values that tend to be gradually larger or smaller as farther away from the central position of the two-dimensional filter.

The above arrangement sequentially encodes filter coefficients sorted in either ascending or descending order of absolute value. The above arrangement can thus achieve the advantage of reducing the amount of encoded data as compared to a case of sequentially encoding filter coefficients arranged in a predetermined order (for example, a raster scan order).

The central position of a two-dimensional filter refers to, in the case where filter coefficients are arranged in a rectangular pattern of M rows and N columns, the position of an element on an i-th row and a j-th column below. In the case where M is an odd number, i=M/2, whereas in the case where M is an even number, i=(M+1)/2, and i=(M−1)/2. Similarly, in the case where N is an odd number, j=N/2, whereas in the case where N is an even number, j=(N+1)/2 and j=(N−1)/2. Further, a filter coefficient on a k-th row and an 1-th column has a distance from the central position of the two-dimensional filter which distance is defined as one of d=|k−i|+|1−j|, d=(k−i)²+(1−j)², and d=max(|k−i|, |1−j|) (the smallest value for d in the case where there are more than one value for i or j).

In order to solve the above problem, a decoder of the present invention is a decoder for decoding, from encoded data that has been compression-encoded, a filter coefficient set including at least a part of filter coefficients included in a two-dimensional filter for use as an adaptive interpolation filter or an adaptive loop filter, the decoder including: decoding means for decoding the at least a part of filter coefficients in the filter coefficient set from the encoded data for each symbol; and inverse sorting means for sorting, in a predetermined order, a filter coefficient set that is obtained by the decoding means and that is arranged in correspondence with a distance from a central position of the two-dimensional filter.

The above arrangement can decode, from encoded data obtained by the above encoder, a filter coefficient set arranged in a predetermined order (for example, a raster scan order).

### Advantageous Effects of Invention

The encoder of the present invention can, as described above, achieve the advantage of effectively reducing, as compared to conventional art, the amount of encoded data for filter coefficients to be transmitted to a decoder.

### BRIEF DESCRIPTION OF DRAWINGS

FIG. 1 is a block diagram illustrating main members of a moving image encoder of Embodiment 1 of the present invention.

FIG. 2 is a block diagram illustrating main members of a filter coefficient encoding section included in the moving image encoder of Embodiment 1 of the present invention.

FIG. 3 illustrates Embodiment 1, where (a) is a diagram schematically illustrating a definition of a distance between each element and a central position in a filter coefficient set placed in a rectangular shape, and (b) is a diagram schematically illustrating an order in which the filter coefficient encoding section of FIG. 2 encodes each element.

FIG. 4 illustrates Embodiment 1, where (a) is another diagram schematically illustrating a definition of a distance between each element and a central position in a filter coefficient set placed in a rectangular shape, and (b) is another diagram schematically illustrating an order in which the filter coefficient encoding section of FIG. 2 encodes each element.

FIG. 5 illustrates Embodiment 1, where (a) is still another diagram schematically illustrating a definition of a distance between each element and a central position in a filter coefficient set placed in a rectangular shape, and (b) is still another diagram schematically illustrating an order in which the filter coefficient encoding section of FIG. 2 encodes each element.

FIG. 6 is a block diagram illustrating main members of a moving image decoder of Embodiment 1 of the present invention.

FIG. 7 is a block diagram illustrating main members of a moving image encoder of Embodiment 2 of the present invention.

FIG. 8 is a block diagram illustrating main members of a filter coefficient encoding section included in the moving image encoder of Embodiment 1 of the present invention.

FIGS. 9(a) and (c) are each a diagram schematically illustrating encoded data of filter coefficients which is transmitted by the moving image encoder of Embodiment 2 to a moving image decoder, and (b) is a diagram schematically illustrating encoded data of filter coefficients which is transmitted by a conventional moving image encoder to a moving image decoder.

FIG. 10 is a block diagram illustrating main members of a moving image decoder of Embodiment 2 of the present invention.

FIG. 11 is a diagram schematically illustrating encoded data of filter coefficients which is transmitted by the moving image encoder of Embodiment 1 to a moving image decoder.

FIG. 12 illustrates Embodiment 1, where (a) is still another diagram schematically illustrating a definition of a distance between each element and a central position in a filter coefficient set placed in a rhombic shape, and (b) is still another diagram schematically illustrating an order in which the filter coefficient encoding section of FIG. 2 encodes each element.

FIG. 13 illustrates Embodiment 1, where (a) is still another diagram schematically illustrating a definition of a distance between each element and a central position in a filter coefficient set placed in a oblique segment shape, and (b) is still another diagram schematically illustrating an order in which the filter coefficient encoding section of FIG. 2 encodes each element.

FIG. 14 is a block diagram illustrating main members of a filter coefficient decoding section included in the moving image decoder of Embodiment 1 of the present invention.

FIG. 15 is a block diagram illustrating main members of a filter coefficient decoding section included in the moving image decoder of Embodiment 2 of the present invention.

FIG. 16 is another diagram schematically illustrating encoded data of filter coefficients which is transmitted by the moving image encoder of Embodiment 2 to a moving image decoder.

FIG. 17 is still another diagram schematically illustrating encoded data of filter coefficients which is transmitted by the moving image encoder of Embodiment 2 to a moving image decoder.

FIG. 18 is a flowchart of an operation of the moving image encoder of Embodiment 1 for decoding filter coefficients.

FIG. 19 is a flowchart of an operation of the moving image encoder of Embodiment 2 for decoding filter coefficients.

FIG. 20 is a flowchart of another operation of the moving image encoder of Embodiment 2 for decoding filter coefficients.

FIG. 21 is a flowchart of still another operation of the moving image encoder of Embodiment 2 for decoding filter coefficients.

FIG. 22 is a flowchart of still another operation of the moving image encoder of Embodiment 2 for decoding filter coefficients.

FIG. 23 is another diagram schematically illustrating encoded data of filter coefficients which is transmitted by the moving image encoder of Embodiment 1 to a moving image decoder.

FIG. 24 is a diagram illustrating example Golomb codes for respective states.

FIG. 25 is a diagram illustrating a selection table that associates the absolute value of an immediately previously encoded or decoded filter coefficient with the value of a state for use in Golomb encoding.

FIG. 26 is a diagram illustrating (i) an accumulated amount of encoded data and (ii) encoded data for a case in which a conventional moving image encoder encodes filter coefficients on the basis of Golomb coding.

FIG. 27 shows diagrams each illustrating (i) an accumulated amount of encoded data and (ii) encoded data for a case in which the moving image encoder of Embodiment 1 encodes filter coefficients on the basis of Golomb coding, where (a) is a diagram illustrating an example involving no sorting process carried out, and (b) is a diagram illustrating an example involving a sorting process carried out.

### DESCRIPTION OF EMBODIMENTS

### Embodiment 1

The description below deals with a moving image encoder of an embodiment of the present invention with reference to drawings.

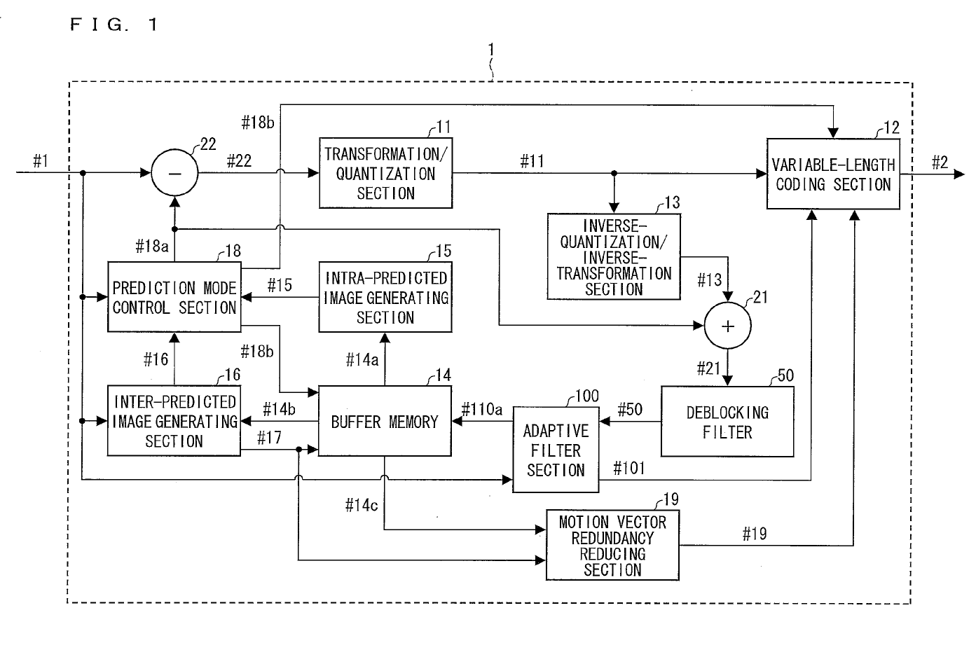

FIG. 1 is a block diagram illustrating main members of the moving image encoder.

(Moving Image Encoder 1)

The moving image encoder 1 is a moving image encoder that includes a part which is based on H.264/AVC standard and a technique being studied by the VCEG.

The moving image encoder 1, as illustrated in FIG. 1, includes: a transformation/quantization section 11; a variable-length coding section 12; an inverse-quantization/inverse-transformation section 13; a buffer memory 14; an intra-predicted image generating section 15; an inter-predicted image generating section 16; a prediction mode control section 18; a motion vector redundancy reducing section 19; an adder 21; a subtracter 22; a deblocking filter 50; and an adaptive filter section 100.

The moving image encoder 1 is supplied with an input image #1, which is divided into block images (hereinafter referred to as “macro blocks”) each constituted by a plurality of adjacent pixels.

The moving image encoder 1 carries out an encoding process with respect to the input image #1, and outputs encoded data #2.

The transformation/quantization section 11 transforms a difference image #22, which is indicative of a difference between (i) the input image #1, divided into macro blocks, and (ii) a predicted image #18a supplied from the prediction mode control section 18 described later, into a frequency component by DCT (discrete cosine transform). The transformation/quantization section then quantizes that frequency component to generate quantized prediction residual data #11. This quantization refers to an arithmetic operation for associating the frequency component with an integer value. The above DCT and quantization are carried out with respect to each of the blocks into which a macro block is divided. The description below uses (i) the term “target macro block” to refer to a macro block targeted for a process and (ii) the term “target block” to refer to a block targeted for a process.

The inverse-quantization/inverse-transformation section 13 decodes the quantized prediction residual data #11 to generate a prediction residual #13. Specifically, the inverse-quantization/inverse-transformation section 13 (i) carries out inverse quantization of the quantized prediction residual data #11, that is, associates the integer value, included in the quantized prediction residual data #11, with a frequency component and (ii) carries out inverse DCT of that frequency component, that is, inversely transforms the target macro block into a pixel component on the basis of the frequency component. The inverse-quantization/inverse-transformation section thus generates a prediction residual #13.

The adder 21 adds the prediction residual #13 to the predicted image #18a to generate a decoded image #21. The decoded image #21 thus generated is supplied to the deblocking filter 50.

The deblocking filter 50, in the case where pixels adjacent to each other across a block border or macro block border in the decoded image #21 have respective pixel values having a difference that is smaller than a predetermined threshold, carries out a deblocking process for that block image data, which has been subjected to a deblocking process, is outputted as a deblocked image #50.

The adaptive filter section 100 calculates, for each pixel value in the inputted image data #50, a weighted linear sum, based on filter coefficients, of pixel values included in a certain region. The adaptive filter section thus generates output image data #110a and outputs it.

The adaptive filter section 100 is supplied with training data #1. The training data #1 refers to, as described below, image data that is referred to for selection of a filter coefficient. A specific example of the training data #1 is input image data inputted to the image encoder that includes the adaptive filter section 100.

The adaptive filter section 100 calculates, for each pixel value in the image data #50, a weighted linear sum, based on a filter coefficient, of pixel values included in a certain region, and carries out addition or the like of an offset value. The adaptive filter section thus calculates output image data #110a.

More specifically, the adaptive filter section 100 calculates a pixel value Sₒ(x′, y′) at coordinates (x′, y′) in the output image data #110a by calculating a weighted linear sum represented by Formula (1).

$$\begin{matrix}[ Math . 1 ] & \\ {S}_{O} ( {x}^{′} , {y}^{′} ) = ( {\sum }_{( i , j ) ∈ R} h ( i , j ) {S}_{I} ( x + i , y + j ) ) + {h}_{offset} & ( 1 )\end{matrix}$$

In the above formula, S_{I}(x, y) represents a pixel value for coordinates (x, y) in image data #50, and h(i, j) represents a filter coefficient by which the pixel value S_{I}(x+i, y+j) is multiplied. R represents a region (hereinafter referred to as “filter reference region”) of pixels of which the weighted linear sum is calculated. More specifically, R represents a set of relative coordinates targeted for the weighted linear sum. In the case where, for instance, filtering is carried out with respect to 3×3 taps having its center at the pixel for the coordinates (x, y), R={(−1, −1), (−1, 0), (−1, 1), (0, −1), (0, 0), (0, 1), (1, −1), (1, 0), (1, 1)}. h_{offset} represents an offset value to be added to a pixel value. The coordinates (x′, y′) may be identical to the coordinates (x, y), or may be different therefrom as long as the coordinates (x′, y′) are in a one-to-one correspondence with the coordinates (x, y). The coordinates (x′, y′) and the coordinates (x, y) do not have a specific correspondence therebetween that limits the present invention, and are determined by a specific arrangement of an image processing device in which the adaptive filter section 100 is mounted.

Filtering for M×N taps is typically characterized by (i) a two-dimensional filter coefficient matrix H, which is an M×N matrix having a filter coefficient h(i, j) for each component, and (ii) the above offset h_{offset}. Among the filter coefficients for use in a filtering process, filter coefficients for respective reference pixels are each associated with a two-dimensional position in correspondence with the position of the reference pixel for that filter coefficient. Such association determines relative positional relationships between the individual filter coefficients.

The description below deals with an example case in which the filter reference region is a rectangular region of M×N taps. The present invention is, however, not limited to such an arrangement, and may be applied to a filter reference region R having any shape such as a rhombus, a circle, a vertical/horizontal segment, and an oblique segment.

Specifically, a filter coefficient matrix H represented by Formula (2) below:

$$\begin{matrix}[ Math 2 ] & \\ H = ( \begin{matrix}{h}_{11} & {h}_{12} & … & {h}_{1 N} \\ {h}_{21} & {h}_{22} & … & {h}_{2 N} \\ & & & \\ {h}_{M 1} & {h}_{M 2} & … & {h}_{MN}\end{matrix} ) & ( 2 )\end{matrix}$$

and offsets h_{offset} are mapped for an (M×N+1)-dimensional filter coefficient vector V defined by Formula (3) below. The description herein refers to the filter coefficient vector V as “filter coefficient set”.

[Math 3]

V=(h₁₁, h₁₂, . . . , h_{1N}, h₂₁, h₂₂, . . . , h_{2N}, . . . , h_{M1}, h_{M2}, . . . , h_{MN}, h_{offset}) (3)

As indicated by Formula (3), the filter coefficient vector

V includes a first component through an (M×N)-th component that each represent a filter coefficient h(i,j). The last component (hereinafter referred to as “offset component”) of the filter coefficient vector V represents an offset h_{offset}.

The above description method allows collective representation of the filter coefficients h(i,j) and the offsets h_{offset}.

The adaptive filter section 100 calculates filter coefficients that minimize the difference between the output image data #110a and the training data #1. Specifically, the adaptive filter section calculates a filter coefficient vector V by the least square method. The filter coefficients thus calculated are then quantized. The quantization refers to a process of allocating an integer to a filter coefficient found as a decimal fraction. The quantization, supposing that, for instance, a filter quantization coefficient is FQP, multiplies a filter coefficient by FQP and rounding off the product to the nearest integer to find a quantized filter coefficient. In other words, DV(i)=floor(V(i)×FQP), where V(i) represents a filter coefficient occurring before quantization, and DV(i) represents a filter coefficient occurring after quantization.

In this case, the filter coefficient is inversely quantized by dividing the quantized filter coefficient by FQP. In other words, the inversely quantized filter coefficient V′(i) is represented by V′(i)=DV(i)/FQP.

It is appropriate to adjust quantized filter coefficients so that the sum of the filter coefficients, each serving as a weight for a reference pixel, is changed as little as possible between before and after quantization and between before and after inverse quantization. Specifically, the present embodiment calculates a difference D (=QSUM1−QSUM0) between (i) QSUM0, which is a value obtained by quantizing the sum of individual components of respective filter coefficients that occur before quantization and that exclude an offset, and (ii) QSUM1, which represents the sum of individual components of filter coefficients that occur after quantization and that exclude an offset. The present embodiment then subtracts the difference D from the greatest one among the filter coefficients that occur after quantization and that exclude an offset. Such subtraction corrects the filter coefficients as quantized.

The adaptive filter section 100 carries out a filtering process with use of quantized filter coefficients, and supplies output image data #110a to the buffer memory 14.

The above process can be represented by the formula A[Σ(DV(i)×SI(i))]+DV(n+1)]/FQP, where DV(i) represents a quantized filter coefficient, SI(i) represents a pixel value referred to for the filtering process, and n+1 represents the number i of an offset element. The present embodiment first carries out a filtering process and then carries out a process for inverse quantization in order to reduce the amount of an arithmetic operation. The present invention may alternately first calculate a coefficient V(i)′ occurring after inverse quantization, and then carries out a filtering operation.

The adaptive filter section 100 outputs filter coefficient information #101, which is information indicative of the filter coefficient vector used for a filtering process. The filter coefficient information #101 is a quantized value.

The adaptive filter section 100 of the present embodiment substantially corresponds to an ALF (adaptive loop filter) in a KTA. In other words, the adaptive filter section 100 of the present embodiment is supplied with the pixel value of a pixel (hereinafter referred to as “integer pixel”) at integer coordinates, and outputs the pixel value of the integer pixel.

The intra-predicted image generating section 15 extracts, from the decoded image #21 stored in the buffer memory 14, a local decoded image #14a (corresponding to a decoded area for a frame identical to a target macro block), and carries out intra prediction on the basis of the local decoded image #14a. The intra-predicted image generating section thus generates an intra-predicted image #15.

The inter-predicted image generating section 16 (i) calculates, for the target block in the input image #1, a motion vector #17 on the basis of a reference image #14b, for which the entire frame has been decoded and which is stored in the buffer memory 14, and (ii) assigns the calculated motion vector to the target block. The motion vector #17 thus calculated is supplied to the predicted image generating section 16 and the motion vector redundancy reducing section 19, and is also stored in the buffer memory 14. The inter-predicted image generating section 16 further carries out motion compensation with respect to the reference image #14b for each block on the basis of the motion vector #17, and thus generates an inter-predicted image #16.

The prediction mode control section 18, for each macro block, compares the intra-predicted image #15, the inter-predicted image #16, and the input image #1. The prediction mode control section thus selects one of the intra-predicted image #15 and the inter-predicted image #16, and outputs the selected one as the predicted image #18a. The prediction mode control section 18 further outputs a prediction mode #18b, which is information indicative of which of the intra-predicted image #15 and the inter-predicted image #16 has been selected. The predicted image #18a is supplied to the subtracter 22.

The prediction mode #18b is stored in the buffer memory 14, and is also inputted to the variable-length coding section 12.

The motion vector redundancy reducing section 19 calculates a prediction vector on the basis of a motion vector group #14c, which has been assigned, after the inter-predicted image generating section 16 has assigned a motion vector #17 to the target block, to other blocks and stored in the buffer memory 14. The motion vector redundancy reducing section 19 calculates the difference between the prediction vector and the motion vector #17, and thus generates a difference motion vector #19. The difference motion vector #19 thus generated is supplied to the variable-length coding section 12.

The subtracter 22 calculates the difference between the input image #1 and the predicted image #18a for the target macro block, and thus outputs a difference image #22.

The variable-length coding section 12 (i) carries out variable-length coding for the quantized prediction residual data #11, the difference motion vector #19, the prediction mode #18b, and the filter coefficient information #101, and thus (ii) generates encoded data #2.

The moving image encoder 1 may alternatively omit the deblocking filter 50, in which case the adaptive filter section 100 carries out a filtering process with respect to not the deblocked image #50 but the decoded image #21.

(Variable-Length Coding Section 12)

The moving image encoder 1 of the present embodiment is characterized by an encoding process carried out by a filter coefficient encoding section 1152 included in the variable-length coding section 12. The description below thus deals in detail with encoding by the filter coefficient encoding section 1152 with reference to drawings.

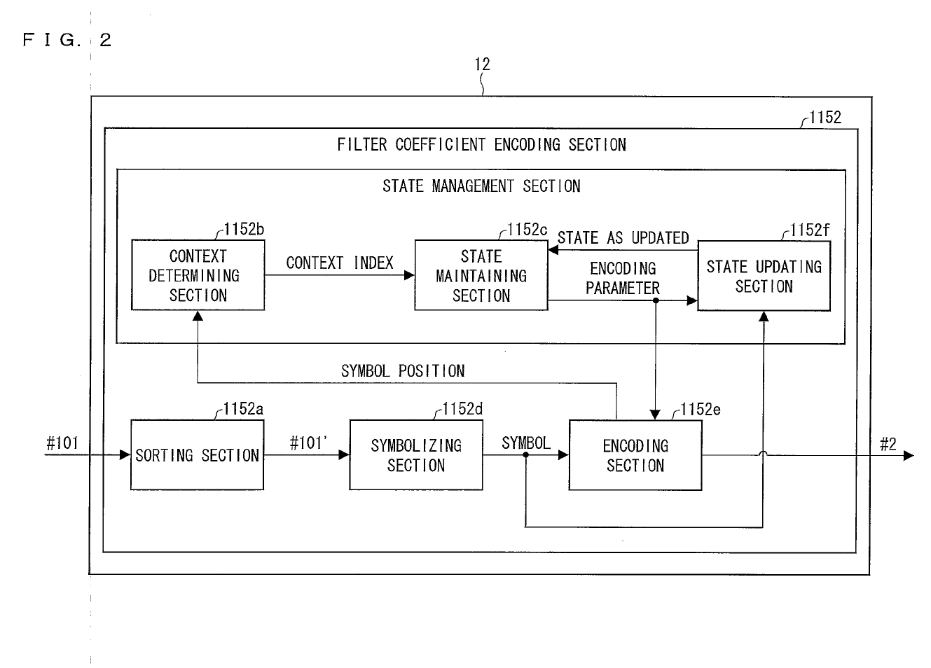

The following first describes an arrangement of the filter coefficient encoding section 1152 with reference to FIG. 2.

(Arrangement of Filter Coefficient Encoding Section 1152)

FIG. 2 is a block diagram illustrating main members of the filter coefficient encoding section 1152.

The filter coefficient encoding section 1152, as illustrated in FIG. 2, includes: a sorting section 1152a; a context determining section 1152b; a state maintaining section 1152c; a symbolizing section 1152d; an encoding section 1152e; and a state updating section 1152f.

The sorting section 1152a carries out, on the basis of relative coordinates of each reference pixel referred to during the filtering process, a sorting process with respect to a part of filter coefficients included in inputted filter coefficient information #101. The sorting section supplies, to the symbolizing section 1152d, filter coefficient information #101a, which has been subjected to the sorting process.

The relative coordinates of the filter coefficients other than a filter coefficient for an offset are basically in a one-to-one correspondence with the relative coordinates of reference pixels. A specific sorting process is thus carried out on the basis of the respective positions of the filter coefficients.

The “sorting process” herein does not refer to a process of sorting n filter coefficients (a₁ through aₙ; the subscripts indicate the order of arrangement of filter coefficients included in the filter coefficient information #101) so that their respective absolute values are completely in ascending order or descending order, that is, a process of sorting filter coefficients in such a manner as to satisfy ^{∀}i (|aᵢ|≦aᵢ₊₁|) or ^{∀}i(|aᵢ|≧|aᵢ₊₁|). The “sorting process” herein refers to a process of, with use of a characteristic of a filter coefficient set applied by the adaptive filter section 100, semi-sorting respective absolute values of the filter coefficients, that is, a process of making the difference extremely large between (i) the number of i that satisfies |aᵢ|≦|aᵢ₊₁| and (ii) the number of i that satisfies |aᵢ|≧|aᵢ₊₁|. This is described later in detail.

The sorting process does not cover a filter coefficient corresponding to an offset. Specifically, the present embodiment treats a filter coefficient for an offset as an (n+1)-th filter coefficient, and carries out no sorting process for it.

The sorting section 1152a supplies filter coefficient information #101a in order of the arrangement (a₁, a₂, a₃ . . . ) of filter coefficients included in the filter coefficient information #101a by supplying one filter coefficient aᵢ (iεn) after another.

The symbolizing section 1152d transforms the filter coefficient aᵢ, supplied from the sorting section 1152a, into a symbol column including a symbol “1” in a number corresponding to the absolute value of the filter coefficient aᵢ. More specifically, the symbolizing section 1152d transforms the filter coefficient aᵢ into a symbol column by (i) including therein consecutive “1”s in a number indicated by the absolute value of the filter coefficient aᵢ, (ii) adding “0” at the end, and (iii) further adding a symbol (“0” for positive, and “1” for negative) indicative of whether the filter coefficient is positive or negative. Thus, the symbolizing section, in the case where, for example, the filter coefficient aᵢ is “−4”, transforms it into a symbol column of “111101”.

The symbolizing section 1152d supplies, to the encoding section 1152e and the state updating section 1152f, one symbol after another from the top of the symbol column.

The context determining section 1152b determines a context for use in encoding of an encoding target bit (symbol) in the symbol column in correspondence with (i) what number coefficient the encoding target coefficient corresponds to in the filter coefficient set having subjected to a sorting process and (ii) what number bit of a symbol the encoding target symbol corresponds to in the encoding target symbol column. The context refers to a group of encoding target bits sharing an identical kind of characteristic (in the present embodiment, respective probabilities of “1” and “0”), and is used for encoding involving a similar probability for an identical group. Specifically, for each bit in a symbol column of the filter coefficient aᵢ, the context determining section 1152b (i) receives, from the encoding section 1152e, symbol position information indicative of what number bit in the symbol column is to be encoded, and (ii) outputs an index indicative of a context for use by the encoding section 1152e. In the present embodiment, the index for i>=1 and i<=9 is 1; the index for 9<i<=n is 2; and the index for i=n+1, that is, for a coefficient corresponding to an offset, is 3. Further, the index for the M-th bit (in the present embodiment, M=8) and its subsequent bits in the symbol column is 4 regardless of i. The index for a symbol indicative of the sign positive or negative is 5 regardless of the above.

The state maintaining section 1152c stores, for each context, an encoding process parameter (respective probabilities of “1” and “0” or states corresponding respectively to such probabilities) for use by the encoding section 1152e. The state maintaining section outputs an encoding process parameter corresponding to the value of a context index.

The encoding section 1152e encodes, on the basis of an encoding process parameter stored in the state maintaining section 1152c, each bit in a symbol column supplied from the symbolizing section 1152d.

Specifically, the encoding section carries out encoding on the basis of an encoding process parameter that is stored in the state maintaining section 1152b and that corresponds to the context index inputted to the state maintaining section 1152b. The present embodiment is characterized in that it encodes a symbol column adaptively, that is, updates, each time it encodes a bit in the symbol column, an encoding process parameter stored in the state maintaining section 1152b.

The state updating section 1152f updates, in correspondence with the value of a immediately previously encoded bit (previous bit) in an symbol column, an encoding parameter for use in encoding of the current bit so that the value of the previous bit is encoded to be shorter. The present embodiment increases the probability of “1” upon receipt of “1”, and decreases the probability of “1” upon receipt of “0”.

The above operation of the state updating section 1152f makes it possible to encode the current filter coefficient in an arithmetic code in correspondence with the magnitude (absolute value) of the value of a previously encoded filter coefficient. This arrangement thus allows a filter coefficient to be encoded with high encoding efficiency.

FIG. 11 illustrates an example structure of encoded data. The following describes adaptive encoding with reference to this drawing by describing an example case in which a symbol column to be inputted to the encoding section 1152e is “111101”. This example case assumes 12 for the position i of a filter coefficient corresponding to the symbol column to be inputted.

The context determining section 1152b outputs, from the position i=12 of the filter coefficient, the value 2 as the value of a context index. The state maintaining section 1152c outputs the probability (P₁ in this example) of “1” in the context 2.

The encoding section 1152e encodes the first bit “1” in “111101” with use of the probability P₁. The encoding section 1152e then outputs the used probability P₁ to the state updating section 1152f. The state updating section 1152f, upon receipt of the probability P₁ from the encoding section 1152e and the encoding bit “1” from the symbolizing section 1152d, updates the probability of “1” in the context 2 to P₂. The probability thus updated is stored in the state maintaining section 1152c.

Next, the encoding section 1152e encodes the second bit “1” in “111101” with use of the probability P₂. The encoding section 1152e then outputs the used probability P₂ to the state updating section 1152f. The state updating section 1152f, upon receipt of the probability P₂ from the encoding section 1152e and the encoding bit “1” from the symbolizing section 1152d, updates the probability of “1” in the context 2 to P₃.

The encoding section similarly encodes “1” of the third and fourth bits in “111101” to update the probability in the context 2 to P₅.

Next, the encoding section 1152e encodes the fifth bit “0” in “111101” with use of a probability 1-P₅. The encoding section 1152e then outputs the used probability P₅ to the state updating section 1152f. The state updating section 1152f, upon receipt of the probability P₅ from the encoding section 1152e and the encoding bit “0” from the symbolizing section 1152d, updates the probability of “1” in the context 2 to P₆.

When the absolute value of the filter coefficient has been decoded, the encoding section finally reads out, from the state maintaining section 1152c, a probability corresponding to a context index 5 for encoding the sign of either positive or negative, and thus encodes the sign of positive or negative (for which the probability is P_{sign}).

The encoding section 1152e, as a result, outputs encoded data obtained by encoding “111101” with use of the probabilities P₁, P₂, P₃, P₄, P₅, and P_{sign}.

When a symbol column at a position i+1 (in this example, 13) of the filter coefficient is then encoded, the present embodiment uses a probability P₆ stored in the context 2.

The encoding section 1152e, through the above process, produces, with use of an occurrence probability in which a greater absolute value for a filter coefficient aᵢ₋₁ causes the probability of “1” to be greater and the probability of “0” to be smaller, an arithmetic code from a symbol column generated from a filter coefficient aᵢ. The filter coefficient information #101a, which has been semi-sorted, allows the difference between (i) the absolute value of the filter coefficient aᵢ₋₁ and (ii) the absolute value of the filter coefficient aᵢ to be small as compared to a case involving no sorting. With this arrangement, the probability at which “1” actually occurs in a symbol column to be encoded tends more to be close to the occurrence probability of “1” for use in arithmetic coding.

The encoding section 1152e, when it has finished a symbol column encoding process for all of the filter coefficients a₁ through aₙ, outputs its stored data to the outside in the order in which it has encoded the individual symbol columns.

The filter coefficient encoding section 1152 may, as for a motion vector, encode a filter coefficient in the form of a difference from its predicted value. The filter coefficient encoding section 1152, in this case, includes itself (i) a filter coefficient predicting section for predicting a filter coefficient and (ii) means for calculating the difference between a filter coefficient and a predicted value. Even in the case where a difference value is encoded, an effect similar to the above is achieved because (i) a difference value also tends to be large for a position closer to a central position and (ii) filter coefficients close to each other tend to have respective absolute values that are close to each other. The filter coefficient predicting section predicts a filter coefficient by, for instance, (i) storing a filter coefficient used in encoding for the previous frame and (ii) using the value of the filter coefficient as a predicted value.

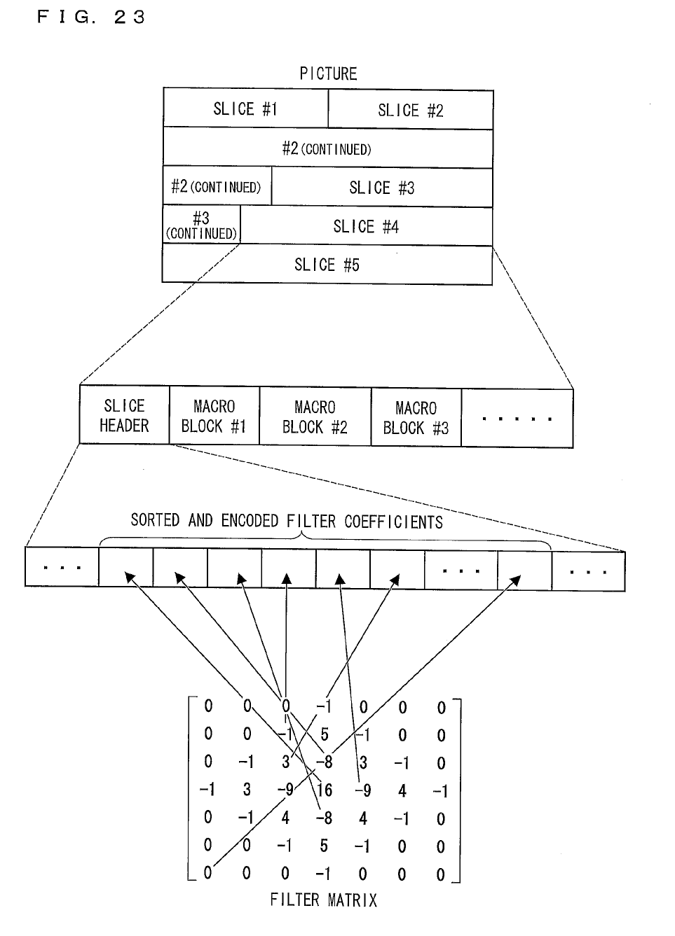

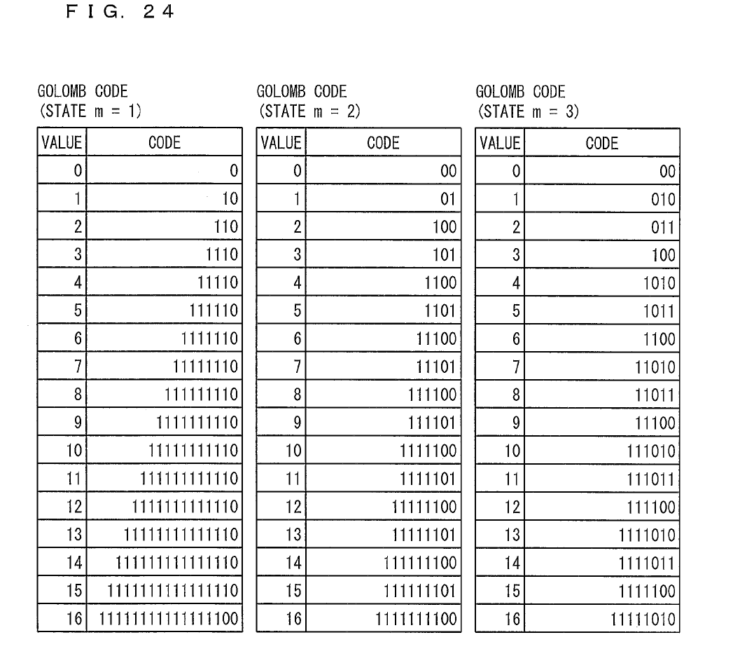

FIG. 23 is a diagram schematically illustrating the above data to be outputted to the outside. The above data is, as illustrated in FIG. 23, stored in the slice header of each slice.

The present embodiment is arranged such that (i) a filter coefficient located closer to a central position corresponds to an encoded symbol stored at a position closer to the top of the slice header and (ii) a filter coefficient located farther from the central position corresponds to an encoded symbol stored at a position closer to the end of the slice header. The present embodiment is thus arranged such that a moving image decoder can, when decoding encoded data to generate a filter coefficient set, refer to the position of each encoded symbol in the slice header as position information indicative of the respective positions of the filter coefficients in a filter coefficient set to be generated.

The filter coefficient encoding section 1152 does not necessarily use arithmetic coding as an algorithm for encoding, and may alternatively use another variable-length coding algorithm such as Huffman coding and Golomb coding. In the case where Huffman coding is used, the filter coefficient encoding section 1152 includes a plurality of Huffman code tables, and the Huffman code tables each include a selection table to which the filter coefficient encoding section 1152 refers in order to select a Huffman code table on the basis of an absolute value. This arrangement allows the filter coefficient encoding section 1152 to select, with reference to a selection table and on the basis of the values of filter coefficients encoded in the encoding order i, a Huffman code table for use in next encoding (that is, for an encoding order i+1). This makes it possible to generate encoded data suitable for a case in which similar absolute values are arranged consecutively. A later description will deal in detail with an example in which Golomb coding is used as a coding algorithm.

(Sorting Process Carried Out by Sorting Section 1152a)

The description below deals with a sorting process carried out by the sorting section 1152a.

As described above, in a filter coefficient vector applied by the adaptive filter section 100, a filter coefficient farther from a central position is smaller in absolute value, and a filter coefficient closer to the central position is larger in absolute value.

The central position herein refers to (i) the center of gravity of a set of reference pixels involved in the filtering process or (ii) the vicinity of the center of gravity. The center is, for instance, (M/2, N/2) for an M×N rectangular two-dimensional filter. The central position may have (i) decimal coordinates or (ii) integer coordinates by means of rounding down, rounding up or the like of decimal coordinates.

The sorting process carried out by the sorting section 1152a of the present embodiment is a process of sorting individual filter coefficients in inputted filter coefficient information #101 in an arrangement order in which, in the case where the filter coefficients are placed two-dimensionally in correspondence with respective relative positions of reference pixels corresponding to the filter coefficients, (i) a filter coefficient closer to the central position precedes a filter coefficient farther from the central position or (ii) a filter coefficient farther from the central position precedes a filter coefficient closer to the central position. This sorting process semi-sorts filter coefficients in order of increasing or decreasing absolute value.

The above sort increases the correlation between filter coefficients as compared to encoding two-dimensionally expressed filter coefficients in a raster order. The above sort thus further improves encoding efficiency in a method of encoding a filter coefficient in correspondence with the value (absolute value) of an immediately previously encoded filter coefficient.

In the case where a single filter coefficient is used as a weight for a plurality of reference pixels, that filter coefficient is placed in correspondence with the relative position of a reference pixel having the greatest weight. In the case where, for instance, an equal filter coefficient is used as a weight coefficient for two reference pixels at respective positions that are symmetric with respect to the central position, there are more than one position for a reference pixel having the greatest weight. In this case, a filter coefficient can be placed by setting such a rule as placing a filter coefficient in correspondence with the relative position of a reference pixel having an X coordinate of 0 or greater.

The above sorting process has some variations. The description below deals with specific examples thereof with reference to drawings. These specific examples of the sorting process apply to the case of the sorting section 1152a sorting filter coefficients in an arrangement order in which a filter coefficient closer to the central position precedes a filter coefficient farther from the central position. The following refers to a filter coefficient set M₁ illustrated in Formula (4) below, a filter coefficient set M₂ illustrated in Formula (5) below, and a filter coefficient set M₃ illustrated in Formula (6) below, each as an example of how individual filter coefficients by the adaptive filter section 100. As is clear from Formulae (4) to (6), a filter coefficient set applied by the adaptive filter section 100 has a strong tendency in which a filter coefficient closer to the central position is larger in absolute value and a filter coefficient farther from the center is smaller in absolute value.

$$\begin{matrix}[ Math 4 ] & \\ {M}_{1} = [ \begin{matrix}0 & 0 & 0 & - 1 & 0 & 0 & 0 \\ 0 & 0 & - 1 & 5 & - 1 & 0 & 0 \\ 0 & - 1 & 3 & - 8 & 3 & - 1 & 0 \\ - 1 & 3 & - 9 & 16 & - 9 & 4 & - 1 \\ 0 & - 1 & 4 & - 8 & 4 & - 1 & 0 \\ 0 & 0 & - 1 & 5 & - 1 & 0 & 0 \\ 0 & 0 & 0 & - 1 & 0 & 0 & 0\end{matrix} ] & ( 4 ) \\ [ Math 5 ] & \\ {M}_{2} = [ \begin{matrix}0 & 0 & 0 & - 1 & 0 & 0 & 0 \\ 0 & 0 & - 2 & 8 & - 3 & 0 & 0 \\ 0 & - 2 & 5 & - 9 & 6 & - 3 & 0 \\ - 1 & 5 & - 9 & 16 & - 8 & 6 & - 3 \\ 0 & - 2 & 4 & - 8 & 4 & - 2 & 0 \\ 0 & 0 & - 2 & 5 & - 2 & 0 & 0 \\ 0 & 0 & 0 & - 2 & 0 & 0 & 0\end{matrix} ] & ( 5 ) \\ [ Math 6 ] & \\ {M}_{3} = [ \begin{matrix}0 & 0 & 0 & 0 & 0 & 0 & 0 \\ 0 & 2 & - 2 & 2 & - 3 & 3 & 0 \\ 0 & - 2 & - 8 & - 7 & 9 & - 3 & 0 \\ 0 & 1 & - 7 & 16 & - 9 & 3 & 0 \\ 0 & - 1 & 7 & - 7 & 7 & - 2 & 0 \\ 0 & 1 & - 1 & 2 & - 2 & 2 & 0 \\ 0 & 0 & 0 & 0 & 0 & 0 & 0\end{matrix} ] \\ ( Specific Example of Sorting Process \text{:} 1 ) & ( 6 )\end{matrix}$$

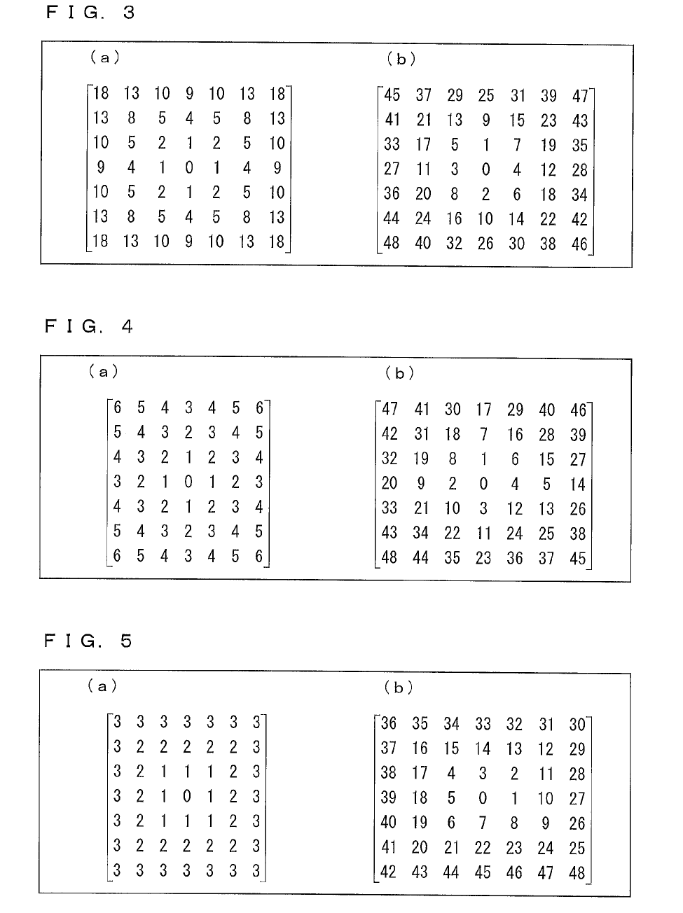

The description below deals with a specific example of the sorting process with reference to FIG. 3.

(a) of FIG. 3 is a diagram schematically illustrating a definition of a distance between the central position and a position relative to the central position in a two-dimensional placement of filter coefficients. (b) of FIG. 3 is a diagram schematically illustrating an order in which the filter coefficient encoding section in FIG. 2 encodes each element.

As illustrated in (a) of FIG. 3, this sorting process is arranged to have, between a relative position and the central position in the two-dimensional filter coefficient placement, a distance defined as the square of a Euclidean distance, that is, d=(k−i)²+(1−j)², where the central position is the position on an i-th row and a j-th column, and the position of each element is the position on a k-th row and an 1-th column. This distance may alternatively be a Euclidean distance, that is, the square root of d.

This sorting process is a process of sorting individual filter coefficients in a filter coefficient set in ascending order of the distance d from the central position in a two-dimensional placement. As a result of this sorting process, the filter coefficient encoding section 1152 encodes each element in the order illustrated in (b) of FIG. 3.

Thus, in the case where this sorting process is applied to the filter coefficient set M₁, the individual filter coefficients of the filter coefficient set M₁ are sorted as follows: a₁=16, a₂==−8, a₃=−8, a₄=−9, a₅=−9, a₆=3, . . . , and a₄₉=0. This indicates that although there are such instances as |a₃|<|a₄| for a₃ and a₄, |aᵢ|≧|a_{i÷1}| in general.

This sorting process may sort, in any order, filter coefficients having an equal distance d from the central position. This sorting process may alternatively set a rule of, for example, assigning sorting priority to (i) a filter coefficient that satisfies (1−j)²<(k−i)² or (ii) in the case where (1−j)² is equal between filter coefficients, a filter coefficient having a smaller 1.

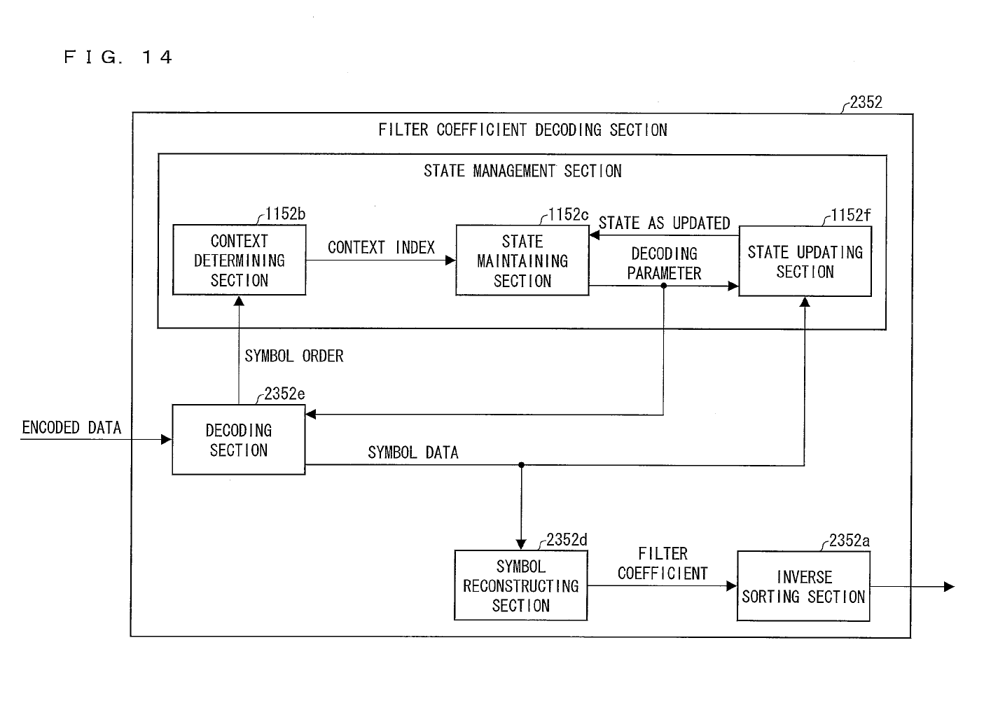

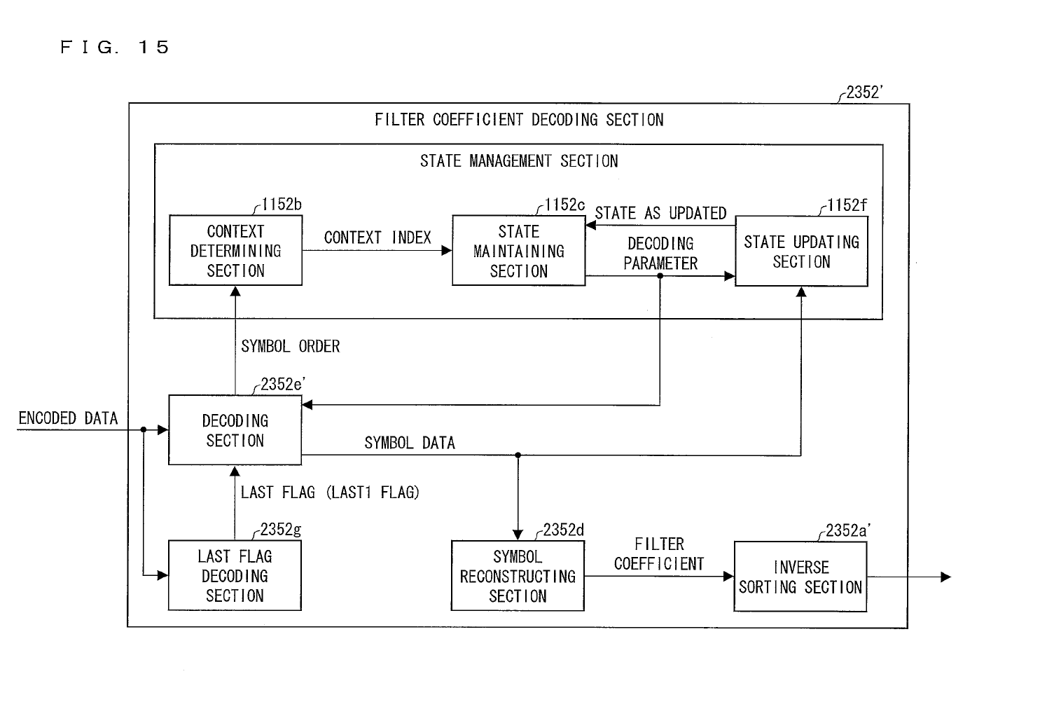

FIGS. 12 and 13 each illustrate an example two-dimensional placement other than a rectangular placement. FIG. 12 illustrates an example of a rhombic placement, whereas FIG. 13 illustrates an example of an oblique segment. (a) of FIG. 12 and (a) of FIG. 13 are each a diagram schematically illustrating a distance definition, whereas (b) of FIG. 12 and (b) of FIG. 13 are each a diagram schematically illustrating a definition of an encoding order. As is clear from (a) of FIG. 12 and (a) of FIG. 13, this sorting process can use the square of a Euclidean distance for a distance definition even in a two-dimensional placement in the shape of a rhombus or an oblique segment.

(Specific Example of Sorting Process: 2)

The description below deals with another specific example of the sorting process with reference to FIG. 4.

(a) of FIG. 4 is a diagram schematically illustrating a definition of a distance between a relative position and the central position in a two-dimensional placement of filter coefficients. (b) of FIG. 4 is a diagram schematically illustrating an order in which the filter coefficient encoding section in FIG. 2 encodes each element.

As illustrated in (a) of FIG. 4, this sorting process is arranged to have, between a relative position and the central position in the two-dimensional filter coefficient placement, a distance defined as d=|k−i|+|1−j|. The central position is (i, j), and the position of each element is (k, 1).

This sorting process is similar to the sorting process of the specific example 1, and is a process of sorting filter coefficients in ascending order of the distance d from the central position in a two-dimensional filter coefficient placement. This sorting process is further characterized in that it gives sorting priority to a filter coefficient placed in the vicinity of the last set filter coefficient over a filter coefficient not placed in the vicinity. The vicinity of a particular position refers to any position that falls within a range of d+δ, where d is the distance from that particular position to its closest filter coefficient. δ is an appropriate threshold, and is set so that in the case where filter coefficients placed in the vicinity are selected, the number of such selected coefficients is a number that is minimally required. In the case where individual filter coefficients in a filter coefficient set applied by the adaptive filter section 100 are placed two-dimensionally, there are many filter coefficient sets, such as the filter coefficient set M₂, in which the difference between the respective absolute values of filter coefficients placed in the vicinity of each other strongly tends to be smaller than the difference between the respective absolute values of filter coefficients not placed in the vicinity of each other. Thus, even a sorting process involving the above order can in many cases semi-sort the filter coefficients.

The filter coefficient encoding section, through this sorting process, encodes each element in the order illustrated in (b) of FIG. 4.

Thus, in the case where this sorting process is applied to the filter coefficient set M₂, the individual filter coefficients of the filter coefficient set M₂ are sorted as follows: a₁=16, a₂=−9, a₃=−9, a₄=−8, a₅=−8, a₆=6, a₇=6, a₈=8, . . . , and a₄₉=0. This indicates that although there are such instances as |a₇|<|a₈| for a₇ and a₈, |aᵢ|≧|aᵢ₊₁| in general.

(Specific Example of Sorting Process: 3)

The description below deals with still another specific example of the sorting process with reference to FIG. 5.

(a) of FIG. 5 is a diagram schematically illustrating a definition of a distance between a relative position and the central position in a two-dimensional placement of filter coefficients. (b) of FIG. 5 is a diagram schematically illustrating an order in which the filter coefficient encoding section in FIG. 2 encodes each element.

As illustrated in (a) of FIG. 5, this sorting process is arranged to have, between each element at a relative position and the element at the center in the two-dimensional coefficient placement, a distance defined as d=max(|k−i|, |1−j|). The central position is (i, j), and the position of each element is (k, 1).

This sorting process is similar to the sorting process of the specific example 2, and is a process of sorting filter coefficients in ascending order of the distance d from the central position in a two-dimensional filter coefficient placement. This sorting process is further characterized in that it gives sorting priority to a filter coefficient placed in the vicinity of the last set filter coefficient over a filter coefficient not placed in the vicinity.

The filter coefficient encoding section, through this sorting process, encodes each element in the order illustrated in (b) of FIG. 5.

Thus, in the case where this sorting process is applied to the filter coefficient set M₃, the individual filter coefficients of the filter coefficient set M₃ are sorted as follows: a₁=16, a₂=−9, a₃=9, a₄=−7, a₅=−8, . . . , and a₄₉=0. This indicates that although there are such instances as |a₄|<|a₅| for a₄ and a₅, |aᵢ|≧|aᵢ₊₁| in general.

The above specific examples 1 to 3 of the sorting process each apply a sorting process to all the filter coefficients. The sorting section 1152a, however, does not necessarily apply a sorting process to all the filter coefficients included in filter coefficient information #101. The sorting section may thus (i) apply no sorting process to filter coefficients each having a distance d of a certain threshold or greater, and (ii) supply, to a later process, such filter coefficients in the original order in which they are stored in the filter coefficient information #101. Even this arrangement can semi-sort the individual filter coefficients in filter coefficient information #101 because a filter coefficient set is, from its nature, arranged such that a filter coefficient having a distance d of a certain threshold or greater is 0 or a sufficiently small value. Further, in the case where the sorting section encodes some filter coefficients in a fixed order, for instance, in the case where the sorting section encodes a filter coefficient at the central position and an offset last, the sorting section sorts filter coefficients other than such some filter coefficients.

Filter coefficients having respective distances that are only slightly different from each other may not be so different from each other in value. The sorting process may thus use, 3, but a distance having a value (quantized value) that roughly expresses the above distance. The sorting process, in this case, uses a value such as Q(d) that involves a quantizing function Q and the above d. The Q can be any monotone increasing function, for example, floor(d/dQ), where (i) floor is a function for outputting an integer obtained by rounding off a decimal fraction to the nearest integer, and (ii) dQ is an integer of 2 or greater. Since there is only a small difference in absolute value between two filter coefficients having respective distances from the central position which distances are large and different from each other, the above distance can suitably be log(d+1) or d raised to the ½ power.

(Example Involving Golomb Coding as Coding Algorithm)

The description below deals with an example involving, as a coding algorithm, not arithmetic coding but Golomb coding, which is variable-length coding.

Golomb coding allocates a short code to a small value and a long code to a large value, and is suitable for encoding of filter coefficients that occur in a distribution in which values converge to 0. Golomb coding can further vary a code with use of a state value m (where m is an integer of 1 or greater) as a parameter, and can thus suitably encode filter coefficients that occur in various distributions different from each other in degree of convergence to 0.

The following describes a method for creating a Golomb code. Golomb coding uses an encoding method that varies according to whether the state value m is (i) 1 or (ii) 2 or greater. In the case of the state value m=1, Golomb coding performs alpha coding (unary). Alpha coding outputs 1 in a number of an integer value x targeted for encoding, and outputs a single 0 last.

In the case where m is 2 or greater, Golomb coding divides an integer value x as an encoding target by m to find a quotient q and a remainder r. Golomb coding encodes the quotient q on the basis of alpha coding, and then finds b0=log2 (m) and b1=ceil(b0), where ceil is a function for outputting an integer obtained by rounding up a decimal fraction to the nearest integer. In the case where b0 is an integer, Golomb coding performs fixed-length encoding of r by a b1 bit. In the case where b1 is not an integer, Golomb coding finds b2=2^{b}−m. In the case of r<b2, Golomb coding performs fixed-length encoding of the remainder r by a b1−1 bit. In the contrary case of r≧b2, Golomb coding performs fixed-length encoding of r+b2 by a b1 bit. Alpha coding may alternately output 0 in a number of an integer value x targeted for encoding, and output a single 1 last. Golomb coding may also output 0 in a number of the value of a quotient q, and output a single 1 last.

With reference to FIGS. 24 through 27, the description below deals with how the moving image encoder 1 operates in the case where it uses Golomb coding as a coding algorithm.

The case involving Golomb coding as a coding algorithm is different from the case involving arithmetic coding in that the symbolizing section 1152d does not transform a filter coefficient into symbols, but directly outputs it to the encoding section 1152e and the state updating section 1152f. The filter coefficient encoding section 1152 thus updates a state each time a filter coefficient is encoded, instead of each time a symbol is encoded. More specifically, the state updating section 1152f updates, in correspondence with the absolute value (previous absolute value) of an immediately previously encoded filter coefficient, an encoding parameter for use in encoding of the current filter coefficient so that the previous absolute value is encoded to be shorter. The state updating section, for instance, updates a state that makes it possible to encode the immediately previously encoded value to be maximally short.

FIG. 24 illustrates example Golomb codes corresponding to the state values m=1, 2, and 3.

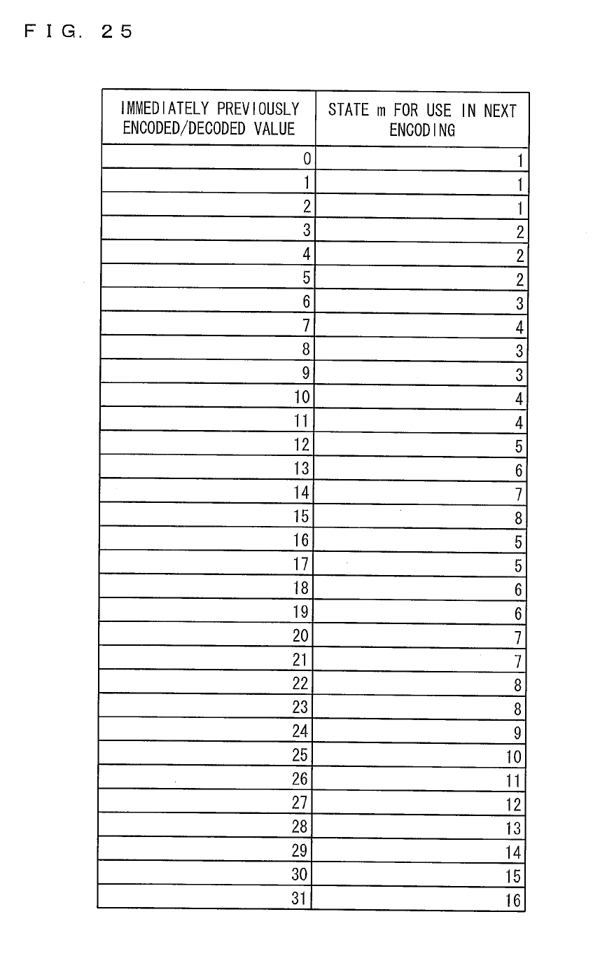

FIG. 25 is an example selection table for selecting, for each immediately previously encoded/decoded filter coefficient, a state value m for use in encoding on the basis of the absolute value of the filter coefficient.

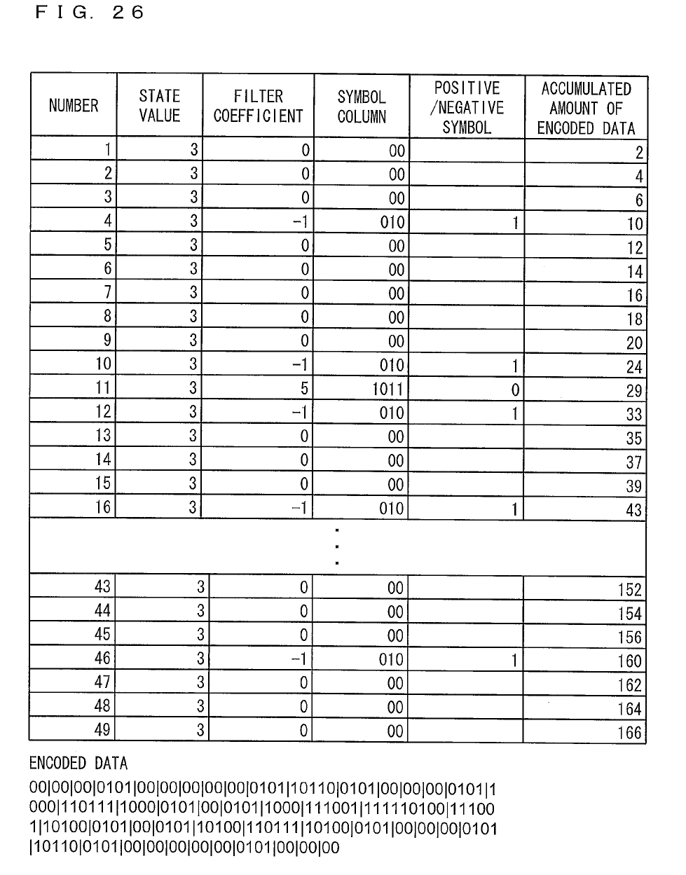

FIG. 26 is a diagram showing (i) a table of an accumulated amount of encoded data for a case in which a conventional moving image encoder carries out encoding with use of Golomb coding without updating a state value m and (ii) encoded data. This diagram deals with an example case of encoding the filter coefficient set M₁ in a raster order with use of Golomb coding with a fixed state value m=3.

The table shown in an upper portion of FIG. 26 includes columns that respectively indicate, from left to right; numbers indicative of an encoding order; state values m for use in Golomb coding; filter coefficients as encoding targets; symbol columns each obtained by encoding the absolute value of a filter coefficient; positive/negative symbols each indicative of whether a filter coefficient is positive or negative; and an accumulated amount of encoded data. FIG. 26 shows, in its lower portion, encoded data generated by a conventional moving image encoder, the encoded data being a column of binary numbers. The lower portion of FIG. 26 shows the delimiter sign “|” in the encoded data. This sign is, however, shown merely for convenience to distinguish the individual symbols for filter coefficients, and thus no data for “|” is included in the encoded data.

The example of FIG. 26 first (i) encodes the value 0 of a filter coefficient by connecting the symbol column “00” with “(empty)” of the positive/negative symbol into the symbol column “00”, with the result that the accumulated amount of filter coefficient by connecting the symbol column “00” with “(empty)” of the positive/negative symbol into the symbol column “00”, with the result that the accumulated amount of encoded data is 4 bits. Encoding all the 49 filter coefficients results in a final accumulated amount of encoded data (that is, the amount of encoded data for a filter coefficient set) being 166 bits. This example has selected the state value m=3 as a value for minimizing the amount of encoded data. Thus, Golomb coding, which uses a fixed state, cannot achieve an encoding efficiency higher than this example.

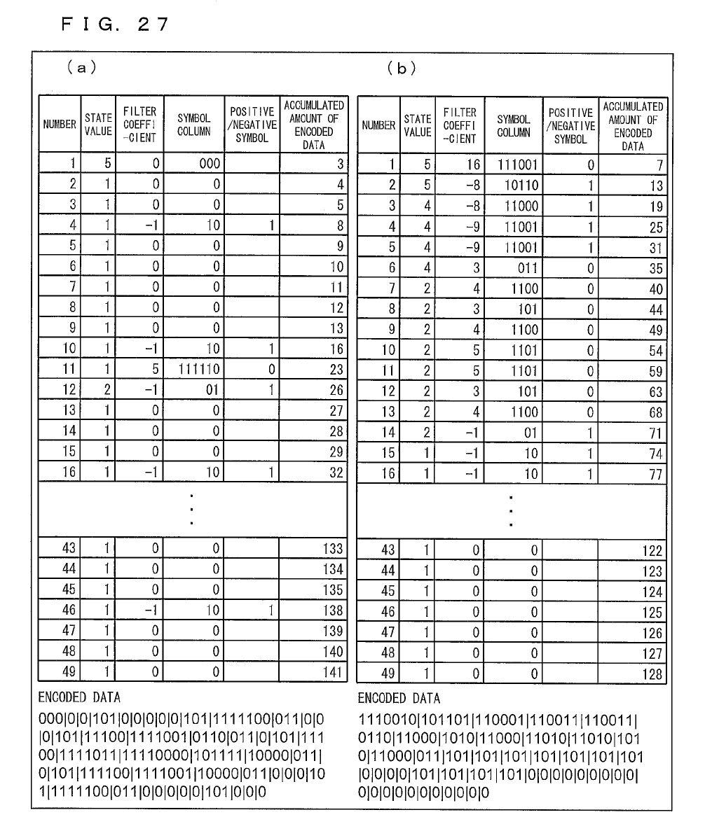

(a) and (b) of FIG. 27 are each a diagram including (i) a table showing an accumulated amount of encoded data for a case in which the moving image encoder 1 carries out encoding on the basis of Golomb coding while updating the state value m and (ii) example encoded data. In each of (a) and (b) of FIG. 27, how the table is read and how encoded data is written are identical to those for FIG. 26.

(a) of FIG. 27 is a diagram for a case involving no sorting process applied, whereas (b) of FIG. 27 is a diagram for a case involving a sorting process applied in accordance with the order illustrated in (b) of FIG. 3.

The example of (a) of FIG. 27 has an initial state in which m=5. The encoding section 1152e first carries out encoding with use of 3 bits on the basis of Golomb coding in which the state value m=5. The state updating section 1152f then selects a state value m for Golomb coding with reference to the selection table illustrated in FIG. 25, and updates the state value m stored in the state maintaining section 1152c. Specifically, the state updating section refers to the selection table to obtain the state value of 1 from an immediately previously encoded value of 0, and thus updates the state value m to 1.

The encoding section 1152e second (i) obtains from the state updating section 1152f the updated state value (encoding process parameter) of 1, and thus (ii) on the basis of Golomb coding in which the state value m=1, encodes the filter coefficient value of 0 by connecting the symbol column of “0” with “(empty)” of the positive/negative symbol into the symbol column “0”. Encoding all the filter coefficients as such results in a final amount of encoded data being 141 bits. This arrangement reduces the amount of encoded data for a filter coefficient set more greatly than in a case where the state value m is not updated.

In the example of (b) of FIG. 27, the moving image encoder 1 carries out encoding by (i) carrying out a sorting process with respect to filter coefficients in the order illustrated in (b) of FIG. 3, and then (ii) updating the state stored in the state maintaining section 1152c in correspondence with the absolute value of an immediately previously encoded filter coefficient. The filter coefficients are, as a result of the sorting process, sorted in the following encoding order: 16, −8, −8, −9, −9, 3, 4, 3, 4, 5, 5, 3, 4, −1, −1, −1, −1, −1, −1, −1, 0, 0, 0, 0, −1, −1, −1, −1, 0, 0, 0, 0, 0, 0, 0, 0, 0, 0, 0, 0, 0, 0, 0, 0, 0, 0, 0, 0.

The example of (b) of FIG. 27 also has an initial state of m=5. The encoding section 1152e first encodes the filter coefficient value of 16 by connecting the symbol column “111001” with “0” of the positive/negative symbol into the symbol column “1110010”. This results in an accumulated amount of encoded data being 7 bits. The state updating section 1152f then selects a state value m for Golomb coding with reference to the selection table illustrated in FIG. 25, and updates the state value m stored in the state maintaining section 1152c. Specifically, the state updating section refers to the selection table to obtain the state value of 5 from the absolute value of 16 of an immediately previously encoded filter coefficient, and thus updates the state value m to 5.

The encoding section 1152e second (i) obtains from the state updating section 1152f the updated state value (encoding process parameter) of 5, and thus (ii) on the basis of Golomb coding in which the state value m=5, encodes the filter coefficient value of 8 by connecting the symbol column of “10110” with “1” of the positive/negative symbol into the symbol column “101101”. Encoding all the filter coefficients as such results in a final amount of encoded data being 128 bits. This indicates that even in the case where the state value m is updated, the amount of encoded data for a filter coefficient set can be reduced more by applying a sorting process than by applying no sorting process.

The state updating section 1152f in this example updates the state in correspondence with only the absolute value of an immediately previously encoded filter coefficient. It is also suitable for the state updating section to alternatively update the state in correspondence with the immediately previous state in addition to the above absolute value. More specifically, in the case where the state updating section refers to the average of (i) a state obtained from the selection table and (ii) an immediately previous state as an update value for the state, it is possible to prevent a sudden change in the state. This arrangement can prevent an increase in the amount of encoded data even in the case where the absolute value does not increase or decrease monotonously.

(Advantage of Moving Image Encoder 1)

As described above, the moving image encoder 1 includes (i) an adaptive filter section 100 for applying an adaptive loop filter to an input image and (ii) a variable-length coding section 12 for encoding the absolute value of each filter coefficient in a filter coefficient set serving as a filter to be applied to the input image.

The variable-length coding section 12 encodes the absolute value of each filter coefficient in correspondence with the absolute value of an already encoded filter coefficient in (i) ascending order of the distance from the central position in a two-dimensional placement of a filter coefficient set and/or (ii) ascending order of the distance from a target filter coefficient.

The adaptive filter section 100 applies an adaptive loop filter including filter coefficients arranged such that (i) a filter coefficient located away from the central position by a larger distance in a two-dimensional placement tends to be smaller in absolute value and that (ii) a filter coefficient closer to the central position in a two-dimensional placement tends to be larger in absolute value. Further, filter coefficients close to each other tend to have respective absolute values that are close to each other.

The moving image encoder 1 can thus increase efficiency of encoding filter coefficients with use of correlation between filter coefficients applied for encoding, that is, with use of the fact that the absolute value of a filter coefficient is close to that of an immediately previously encoded filter coefficient.

The above arrangement advantageously allows an encoder to, as compared to conventional art, effectively reduce the amount of encoded data for filter coefficients to be transmitted to a decoder.

In the case where the moving image encoder uses generates a symbol column including prescribed symbols in a number corresponding to the absolute value of a filter coefficient and (ii) carries out arithmetic coding with respect to the generated symbol column in correspondence with the respective occurrence probabilities of symbols in an already encoded symbol column. This arrangement allows use of occurrence probabilities that are close to actual probabilities of occurrence of symbols, and thus achieves a particularly effective operation.

(Moving Image Decoder)

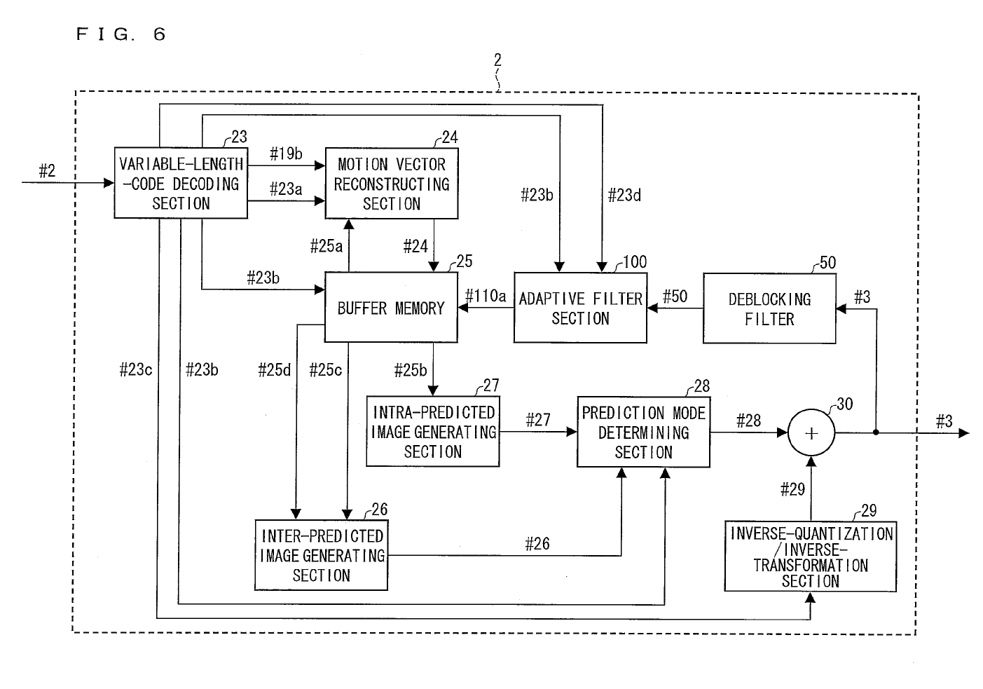

The description below now deals with a moving image decoder of the present embodiment with reference to FIG. 6.

FIG. 6 is a block diagram illustrating main members of the moving image decoder.

The moving image decoder 2 is a moving image decoder that includes a part which is based on H.264/AVC standard and a technique being studied by the VCEG.

The moving image decoder 2, as illustrated in FIG. 6, includes: a variable-length-code decoding section 23; a motion vector reconstructing section 24; a buffer memory 25; a predicted image generating section 26; an intra-predicted image generating section 27; a prediction mode determining section 28; an inverse-quantization/inverse-transformation section 29; an adder 30; a deblocking filter 50; and an adaptive filter section 100.

The moving image decoder 2 receives encoded data #2 and outputs an output image #3.

The variable-length-code decoding section 23 carries out variable-length decoding with respect to the encoded data #2, and outputs a difference motion vector #23a, side information #23b, quantized prediction residual data #23c, and filter coefficient information #23d.

The motion vector reconstructing section 24 decodes a motion vector #24 for a target partition on the basis of (i) the difference motion vector #23a and (ii) a motion vector #25a that has already been decoded and stored in the buffer memory 25.

The buffer memory 25 stores (i) output image data #110a outputted from the adaptive filter section 100, (ii) the motion vector #24, and (iii) the side information #23b.

The inter-predicted image generating section 26 generates an inter-predicted image #26 on the basis of (i) a motion vector #25c that has been decoded by the motion vector reconstructing section 24 and inputted via in the buffer memory 25 and (ii) a reference image #25d stored in the buffer memory 25. The motion vector #25c includes a motion vector identical to the motion vector #24. The reference image #25d corresponds to an output image data #110a outputted from the adaptive filter section 100 described below.

The intra-predicted image generating section 27 generates an intra-predicted image #27 on the basis of a local decoded image #25b that is (i) included in an image in which a target macro block is included and that is (ii) stored in the buffer memory 25.

The prediction mode determining section 28 selects one of the intra-predicted image #27 and the inter-predicted image #26 on the basis of prediction mode information included in the side information #23b, and thus outputs the selected one as a predicted image #28.

The inverse-quantization/inverse-transformation section 29 carries out inverse quantization and inverse DCT with respect to the quantized prediction residual data #23c, and thus outputs a prediction residual #29.

The adder 30 adds the prediction residual #29 to the predicted image #28, and thus outputs a result of the addition as a decoded image #3. The decoded image #3 thus outputted is supplied to the deblocking filter 50.

The deblocking filter 50, in the case where pixels adjacent to each other across a block border or macro block border in the decoded image #3 have respective pixel values having a difference that is smaller than a predetermined threshold, carries out a deblocking process for that block border or macro block border in the decoded image #3. This image data, which has been subjected to a deblocking process, is outputted as a deblocked image #50.

The adaptive filter section 100 carries out a filtering process with respect to the deblocked image #50.

(Variable-Length-Code Decoding Section 23)

The moving image encoder 2 of the present embodiment is characterized by a decoding process carried out by a filter coefficient decoding section 2352 included in the variable-length-code decoding section 23.

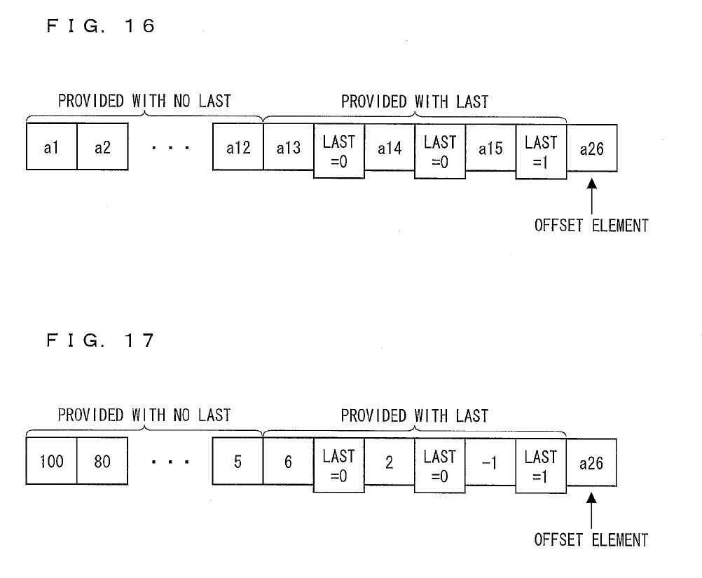

The description below first deals with an arrangement of the filter coefficient decoding section 2352 with reference to FIG. 14.

(Arrangement of Filter Coefficient Decoding Section 2352)

FIG. 14 is a block diagram illustrating main members of the filter coefficient decoding section 2352.

The filter coefficient decoding section 2352, as illustrated in FIG. 14, includes: an inverse sorting section 2352a; a context determining section 1152b; a state maintaining section 1152c; a symbol reconstructing section 2352d; a decoding section 2352e; and a state updating section 1152f. The description below does not deal with the context determining section 1152b, the state maintaining section 1152c, and the state updating section 1152f, which are members that are already described above.

The decoding section 2352e receives (i) a decoding parameter (probability or state) outputted from the state maintaining section 1152c in response to a context index outputted from the context determining section 1152b and (ii) encoded data #2. The decoding section, in response, decodes an arithmetic code, and outputs, to the symbol reconstructing section 2352d, a resulting symbol column including binary numbers.

The symbol reconstructing section 2352d transforms each symbol in the symbol column into a filter coefficient, and outputs the filter coefficient to the inverse sorting section 2352a.

The inverse sorting section 2352a, on the basis of the order of decoding inputted filter coefficients, sorts the filter coefficients in an order of the filter coefficients which order is required by the adaptive filter section 100. Specifically, the inverse sorting section (i) utilizes the fact that the order of decoding individual filter coefficients is in a one-to-one correspondence with the respective positions of the individual filter coefficients for a case in which the filter coefficients are placed two-dimensionally on the basis of respective relative positions of reference pixels corresponding respectively to the filter coefficients, and thus (ii) sorts the individual filter coefficients in an order for a case in which the two-dimensionally placed filter coefficients are raster-scanned. Since the reference pixels referred to by the adaptive filter section 100 during filtering are read in a raster scan order, it is suitable for the filter coefficients to be processed in a raster scan order as well.

The reference pixels corresponding respectively to the filter coefficients are as described above. The order of decoding filter coefficients is identical to the above-described order of encoding filter coefficients. Specifically, (i) a filter coefficient located more closely to (or farther from) the central position in a two-dimensional filter coefficient placement is decoded earlier, and/or (ii) filter coefficients located closely to an immediately previously decoded filter coefficient are decoded consecutively.

The filter coefficient decoding section decodes, in a fixed order, filter coefficients that have been encoded in a fixed order, such filter coefficients including (i) a filter coefficient, such as an offset, that corresponds to no reference pixel and (ii) a filter coefficient that is located at the central position and that was encoded before an offset.

The filter coefficient decoding section 2352, similarly to the filter coefficient encoding section 1152, decodes encoded data #2 with use of the characteristic that the difference in absolute value between a filter coefficient aᵢ₋₁ and a filter coefficient aᵢ is small. The filter coefficient decoding section can thus decode encoded data #2 with high efficiency. As described above, the semi-sorted filter coefficients having the above characteristic are each restored by the inverse sorting section 2352a to its original position observed before the semi-sorting.

The filter coefficient decoding section 2352 may, as for a motion vector, decode a filter coefficient encoded in the form of a difference from its predicted value. The filter coefficient decoding section 2352, in this case, includes itself (i) a filter coefficient predicting section and (ii) means for adding a difference value to a predicted value. Even in the case where a difference value is decoded, an effect similar to the above is achieved because (i) a difference value also tends to be large for a position closer to a central position and (ii) filter coefficients close to each other tend to have respective absolute values that are close to each other. The filter coefficient predicting section predicts a filter coefficient by, for instance, (i) storing a filter coefficient used in encoding for the previous frame and (ii) using the value of the filter coefficient as a predicted value.

The filter coefficient decoding section 2352 does not necessarily use arithmetic decoding as a decoding algorithm for decoding, and may alternatively use variable-length decoding such as Huffman decoding and Golomb decoding. In the case where Huffman decoding is used, the filter coefficient decoding section 2352 includes a plurality of Huffman code tables, and the Huffman code tables each include a selection absolute value of a filter coefficient. This arrangement allows the filter coefficient decoding section to select, with reference to a selection table and a result of decoding based on a decoding order i, a Huffman code table for use in next decoding (that is, for a decoding order i+1). This makes it possible to decode encoded data with reference to a Huffman code table.

With reference to FIGS. 24 through 27 again, the description below deals in detail with an example in which the moving image decoder 2 of the present embodiment uses not arithmetic decoding but Golomb decoding as a decoding algorithm. The case involving Golomb decoding as a decoding algorithm is different from the case involving arithmetic decoding in that (i) the decoding section 2352e outputs not a symbol but a filter coefficient to the state updating section 1152f and the symbol reconstructing section 2352d, and (ii) the symbol reconstructing section 2352d receives not a symbol but a filter coefficient from the decoding section 2352d, and outputs the received filter coefficient directly to the inverse sorting section 2352a. The filter coefficient decoding section 2352 thus updates a state each time a filter coefficient is decoded, instead of each time a symbol is decoded.

The moving image decoder 2 carries out decoding while updating, in correspondence with the absolute value of an immediately previously decoded filter coefficient, a state stored in the state maintaining section 1152c. The moving image decoder 2, as well as the moving image encoder 1, stores the selection table illustrated in FIG. 25. The state updating section 1152f selects a state value m for Golomb coding with reference to the selection table. The state stored in the state maintaining section 1152c has an initial value equal to that for the moving image encoder 1, the initial value being 5 in this example.

The following describes, with reference to (a) of FIG. 27, an example of decoding data that has been subjected to no sorting process and thus encoded by the moving image encoder 1 and, with reference to (b) of FIG. 27, an example of (i) decoding data that has been subjected to a sorting process and thus encoded by the moving image encoder 1 and (ii) carrying out an inverse sorting process.

Described below first is the example of decoding data that has been subjected to no sorting process and thus encoded by the moving image encoder 1 (that is, an example involving no inverse sorting process).

The decoding section 2352e, as illustrated in (a) of FIG. 27, first decodes the symbol “000” on the basis of Golomb coding in which the state value m=5, and thus obtains the absolute value 0 for a filter coefficient. Since the absolute value of this filter coefficient is 0, the positive/negative symbol is “(empty)”. The state updating section 1152f then (i) receives the filter coefficient 0 from the decoding section 2352e, (ii) refers to a selection table to obtain the state value of 1, and (iii) updates, to the value of 1, the state stored in the state maintaining section 1152c.

The decoding section 2352e second receives from the state maintaining section 1152c the state value (encoding process parameter) of 1. The decoding section then decodes the symbol “0” on the basis of Golomb coding in which the state value m=1, and thus obtains the absolute value 0 for a filter coefficient. Similarly decoding all the other filter coefficients can decode 141 bits of encoded data. In the case where the state value m is fixedly 3 as illustrated in FIG. 26, 166 bits of encoded data is decoded. This indicates that the moving image decoder 2 can decode encoded data more efficiently. This decoding provides filter coefficients in the following order: 0, 0, 0, −1, 0, 0, 0, 0, 0, −1, 5, −1, 0, 0, 0, −1, 3, −8, 3, −1, 0, −1, 3, −9, 16, −9, 4, −1, 0, −1, 4, −8, 4, −1, 0, 0, 0, −1, 5, −1, 0, 0, 0, 0, 0, −1, 0, 0, 0. This order corresponds to an order of raster-scanning filter coefficients that are placed two-dimensionally.

Described below now is the example of (i) decoding data that has been subjected to a sorting process and thus encoded by the moving image encoder 1 and (ii) carrying out an inverse sorting process.

As illustrated in (b) of FIG. 27, the moving image encoder 2, as in the case involving no inverse sorting process, carries out decoding while updating the state in correspondence with the absolute value of an immediately previously encoded filter coefficient. The decoding section 2352e first decodes the symbol “111001” on the basis of Golomb coding in which the state value m=5, and thus obtains the absolute value 16 for a filter coefficient. Since the positive/negative symbol “0” indicates that this filter coefficient is positive, the decoding section 2352e decodes this filter coefficient into the value of 16. The state updating section 1152f then (i) receives the filter coefficient 16 from the decoding section 2352e, (ii) refers to a selection table to obtain the state value of 5, and (iii) updates, to the value of 5, the state stored in the state maintaining section 1152c.

The decoding section 2352e second receives from the state maintaining section 1152c the state value (encoding process parameter) of 5. The decoding section then decodes the symbol “10110” on the basis of Golomb coding in which the state value m=5, and thus obtains the absolute value 8 for a filter coefficient. Since the positive/negative symbol “1” indicates that this filter coefficient is negative, the decoding section can decode this filter coefficient into the value of −8. Similarly decoding all the other filter coefficients can decode 128 bits of encoded data. In the case involving no inverse sorting process, 141 bits of encoded data is decoded as illustrated in (a) of FIG. 27. This indicates that the moving image decoder 2 can decode encoded data more efficiently than in the case involving no inverse sorting process. This decoding provides filter coefficients in the following order: 16, −8, −8, −9, −9, 3, 4, 3, 4, 5, 5, 3, 4, −1, −1, −1, −1, −1, −1, −1, −1, 0, 0, 0, 0, −1, −1, −1, −1, 0, 0, 0, 0, 0, 0, 0, 0, 0, 0, 0, 0, 0, 0, 0, 0, 0, 0, 0, 0. The inverse sorting section 2352a carries out an inverse sorting process in order to sort the filter coefficients, provided in such an order as above, in an order suitable for a filter process, for example, a raster scan order.

(Arrangement of Adaptive Filter Section 100)

The adaptive filter section 100 (i) generates a filter coefficient set on the basis of filter coefficient information #23d generated through decoding by the filter coefficient decoding section 2352, and (ii) carries out a filtering process with use of the filter coefficient set thus generated.

The adaptive filter section 100 outputs, to the buffer memory 25, output image data #110a generated as a result of carrying out a filtering process with respect to a deblocked image #50.

The adaptive filter section 100 in the present use example substantially corresponds to an ALF (adaptive loop filter) in a KTA. In other words, the adaptive filter section 100 of the present use example is supplied with the pixel value of an integer pixel, and outputs the pixel value of an integer pixel. This example corresponds to a case in which x, y, x′, and y′ in Formula (1) are each an integer.

(Advantage of Moving Image Decoder 1)

With the above arrangement, the moving image decoder 1 decodes encoded filter coefficients with high efficiency through effective use of correlation between the filter coefficients. The moving image decoder can thus generate decoded image from encoded data with high efficiency.

### Embodiment 2

The description below deals with a moving image encoder of another embodiment of the present invention with reference to drawings. The moving image encoder of the present embodiment is, as well as the moving image encoder 1 of Embodiment 1, a moving image encoder that includes a part which is based on H.264/AVC standard and a technique being studied by the VCEG.

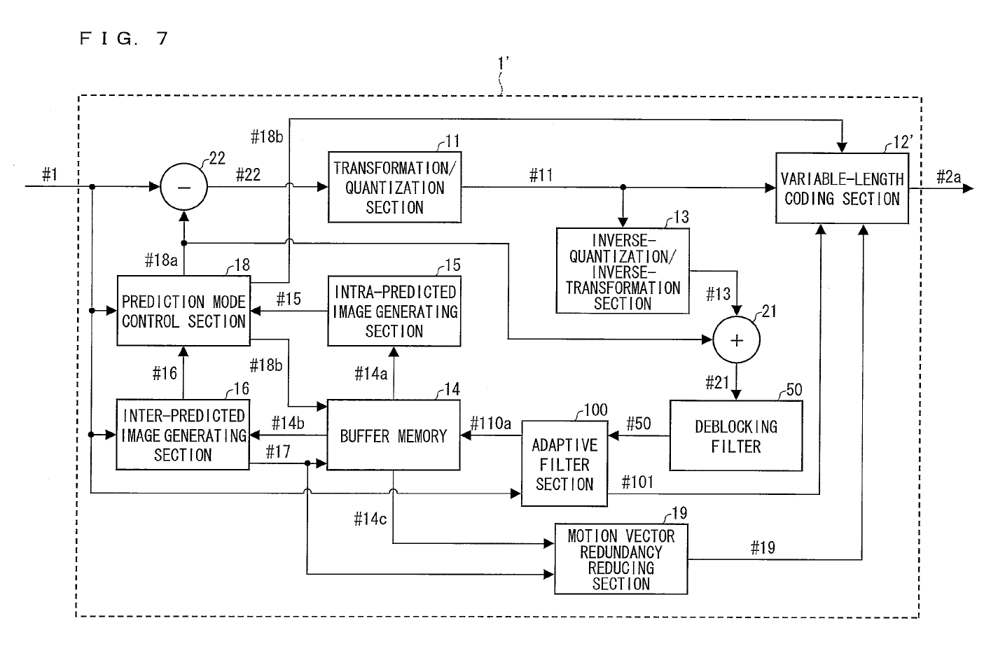

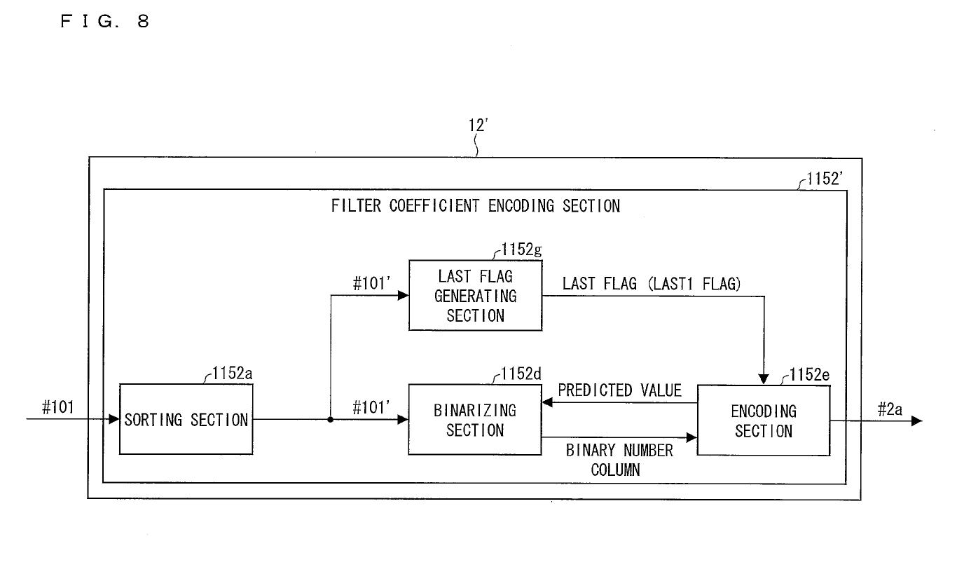

FIG. 7 is a block diagram illustrating main members of a moving image encoder 1′ of the present embodiment.

(Arrangement of Moving Image Encoder 1′)

As illustrated in FIG. 7, the moving image encoder 1′, similarly to the moving image encoder 1, includes: a transformation/quantization section 11; an inverse-quantization/inverse-transformation section 13; a buffer memory 14; an intra-predicted image generating section 15; an inter-predicted image generating section 16; a prediction mode control section 18; a motion vector redundancy reducing section 19; an adder 21; a subtracter 22; a deblocking filter 50; and an adaptive filter section 100. This moving image encoder, however, includes a variable-length coding section 12′ including a filter coefficient encoding section 1152′ that is different in arrangement and function from the filter coefficient encoding section 1152 included in the variable-length coding section 12 of Embodiment 1.

The description below thus deals in detail with the filter coefficient encoding section 1152′, and does not deal with the other members.

(Arrangement of Filter Coefficient Encoding Section 1152′)

The following describes an arrangement of the filter coefficient encoding section 1152′ with reference to FIG. 8.

FIG. 8 is a block diagram illustrating main members of the filter coefficient encoding section 1152′ included in the variable-length coding section 12′.

The filter coefficient encoding section 1152′, as illustrated in FIG. 8, includes: a sorting section 1152a; a binarizing section 1152d; an encoding section 1152e; and a LAST flag generating section 1152g.

The sorting section 1152a carries out a sorting process similar to that carried out by the sorting section 1152a included in the filter coefficient encoding section 1152 of Embodiment 1. Specifically, the sorting process of the present embodiment is a process of sorting filter coefficients, included in inputted filter coefficient information #101, in an arrangement order in which a filter coefficient close to a central position precedes a filter coefficient far from the central position.

The binarizing section 1152d transforms a filter coefficient aᵢ, supplied from the sorting section 1152a, into a symbol column including symbols each represented by a binary number of “0” or “1”. The binarizing section thus supplies this symbol column to the encoding section 1152e.

The LAST flag generating section 1152g determines whether the filter coefficient aᵢ supplied from the sorting section 1152a has an absolute value that is a non-zero coefficient which occurs last. The LAST flag generating section, (i) in the case where the absolute value is not a non-zero coefficient which occurs last, sets the value of a LAST flag to “0”, and (ii) otherwise sets the value to “1”. The LAST flag generating section 1152g thus supplies the LAST flag to the encoding section 1152e.

The encoding section 1152e encodes data that associates (i) the already accepted symbol column for the filter coefficient aᵢ₋₁ with (ii) the LAST flag. The encoding section 1152e, after accepting a LAST flag that has the value “1” and encoding data that associates a symbol column with the LAST flag having the value “1”, (i) does not encode the filter coefficients (aᵢ, aᵢ₊₁, . . . ) remaining in filter coefficient information #101′, and (ii) outputs, to the outside, all the encoded data sorted in the encoding order. The following describes a specific example thereof.

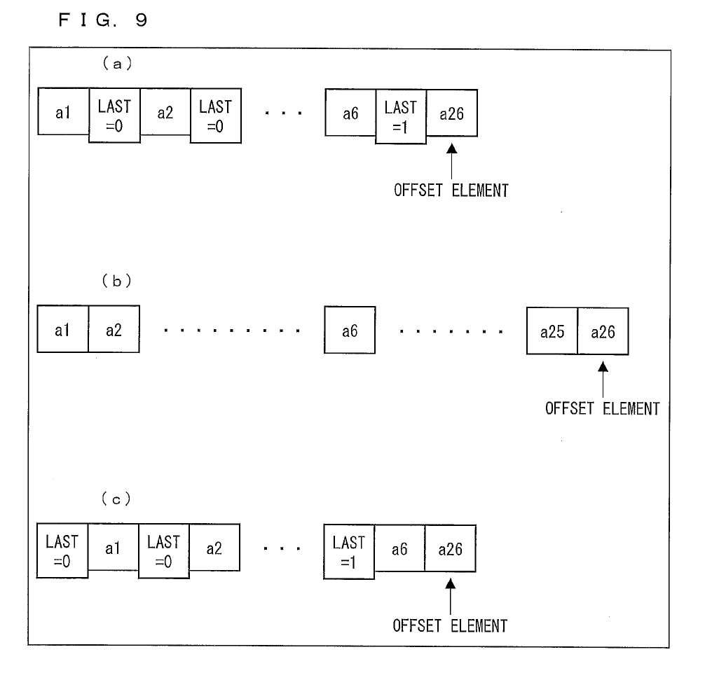

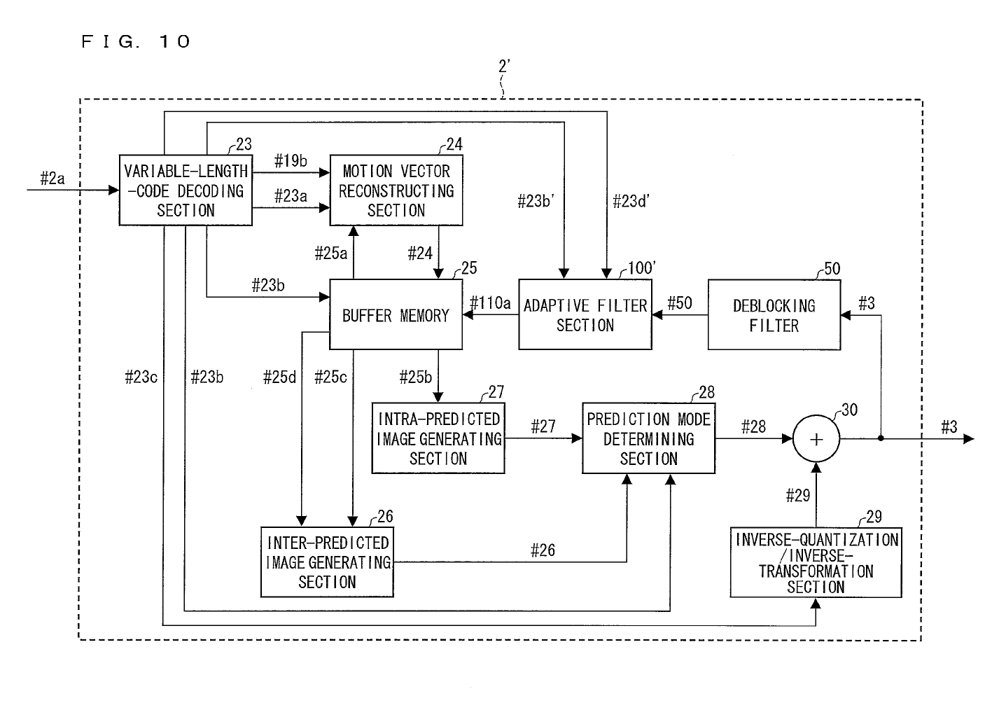

FIG. 9 shows diagrams each schematically illustrating information encoded by the moving image encoder in the case where (i) filter coefficient information #101′ stores filter coefficients a1 through a26 in that order and (ii) the filter coefficients a1 through a6 each have an absolute value other than 0, whereas the filter coefficients a7 and later each have an absolute value of 0. (a) and (c) of FIG. 9 are each a diagram for a case involving the moving image encoder 1′ of the present embodiment as a moving image encoder, whereas (b) of FIG. 9 is a diagram for a case involving a conventional moving image encoder as a moving image encoder.

The encoding section 1152e of the moving image encoder 2′, as illustrated in (a) of FIG. 9, encodes a1, the LAST flag “0”, a2, the LAST flag “0”, . . . , a6, and the LAST flag “1”, but does not encode a3 through a25. On the other hand, the conventional moving image encoder, as illustrated in (b) of FIG. 9, encodes all the filter coefficients a1 through a25.

The encoding section directly encodes the filter coefficient a26, indicative of an offset value, without adding a LAST flag to it. The encoding section may alternatively encode, as illustrated in (c) of FIG. 9, a symbol column including a LAST flag added not to follow but to precede each filter coefficient.

The encoding section 1152e, although requiring an overhead corresponding to the amount of encoded data for LAST flags as compared to conventional art, allows an overall reduction in the amount of encoded data for filter coefficients since the adaptive filter section 100 applies filter coefficients including many filter coefficients each having the value of 0.

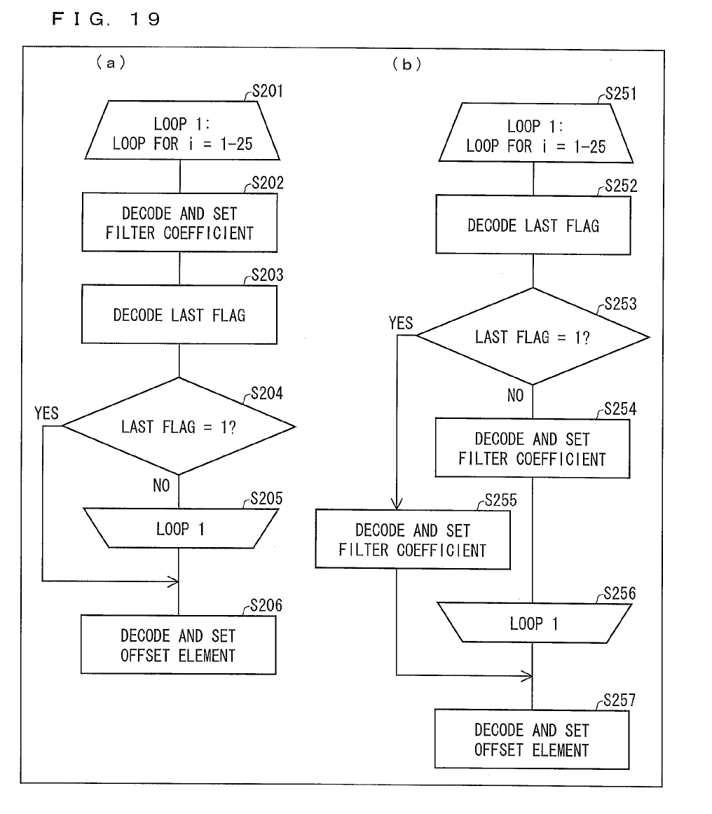

The above description deals with respective operations of the individual sections of the filter coefficient encoding section 1152′. The LAST flag generating section 1152g may alternatively supply, to the encoding section 1152e, LAST flags for only particular filter coefficients (for example, the filter coefficients an/2 and later) among the n filter coefficients (a₁ through aₙ; the subscripts indicate the order of arrangement of filter coefficients included in the filter coefficient information #101). FIG. 16 illustrates example encoded data outputted by the moving image encoder 1′ in the case where LAST flags are added to only particular filter coefficients as above. This example adds LAST flags to the filter coefficients n=13 and later. Encoding LAST flags can thus omit encoding of the filter coefficients from n=16 to n=25. Since the filter coefficient n=26 is an offset coefficient, the encoding section encodes this filter coefficient regardless of the value of a LAST flag.

The moving image encoder may alternatively be arranged such that the encoding section 1152e is supplied with LAST flags for filter coefficients positioned subsequently to the first filter coefficient that has an absolute value of not greater than a predetermined constant TH. FIG. 17 illustrates example encoded data outputted by the moving image encoder 1′ in the case where TH=5. The example of FIG. 17 (i) does not encode a LAST flag for the first filter coefficient that has an absolute value of not greater than TH=5 or any filter coefficient preceding that filter coefficient, and (ii) does encode a LAST flag for any filter coefficient following the first filter coefficient that has an absolute value of not greater than TH=5. In each of the examples of FIGS. 16 and 17, the coefficient n=26, which is an offset coefficient, is encoded regardless of the value of a LAST flag.

The following describes a variation of the process carried out by the filter coefficient encoding section 1152′.

(Variation of Process Carried Out by Filter Coefficient Encoding Section 1152′)

The above description states that the LAST flag generating section 1152g stores a value in a LAST flag and supplies the LAST flag to the encoding section 1152e. The LAST flag generating section may alternatively store a value in a LAST1 flag instead of a LAST flag, and supply the LAST1 flag to the encoding section 1152e.

In this case, the LAST flag generating section 1152g determines whether the filter coefficient aᵢ supplied from the sorting section 1152a has an absolute value that is larger than a predetermined threshold (for example, 0). The LAST flag generating section, (i) in the case where the absolute value is larger than the predetermined threshold, sets the value of a LAST1 flag to “0”, and (ii) otherwise sets the value to “1”. The LAST flag generating section 1152g then supplies the LAST1 flag to the encoding section 1152e. The LAST flag generating section 1152g further stores the sum total of already accepted filter coefficients. The LAST flag generating section 1152g, in the case where the filter coefficient a; has an absolute value that is larger than the predetermined threshold, adds aᵢ to the sum total (a₁+a₂+ . . . +aᵢ₋₁). The LAST flag generating section, in the case where the filter coefficient aᵢ has an absolute value that is not larger than the predetermined threshold, subtracts the last added filter coefficient from the sum total (a₁+a₂+ . . . +aᵢ₋₁), and supplies the resulting value to the encoding section 1152e as a sum total (a₁+a₂+ . . . +aᵢ₋₂).

The encoding section 1152e determines whether its accepted LAST1 flag has a value of “0” or “1”. The encoding section 1152e, in the case where it has determined that the LAST1 flag has a value of “0”, encodes data that associates (i) the already accepted symbol column for the filter coefficient aᵢ₋₂ with (ii) the LAST1 flag.

The encoding section 1152e, in the case where it has determined that the LAST1 flag has a value of “1”, (i) subtracts from 1 the value of the sum total (a₁+a₂+ . . . +aᵢ₋₂), accepted from the LAST flag generating section 1152g, to obtain a predicted value for the filter coefficient aᵢ₋₁, and (ii) supplies the predicted value to the binarizing section 1152d. The present embodiment (i) subtracts from 1 the value of the sum total accepted from the LAST flag generating section 1152g and (ii) uses the resulting value as a predicted value because the adaptive filter section 100 applies a filter including filter coefficients which, excluding an offset value, typically amount to a sum total of a value of approximately 1.

The encoding section 1152e then receives from the binarizing section 1152d a symbol column including difference values, and encodes the difference values. The encoding section 1152e, in the case where it has encoded difference values, does not encode filter coefficients remaining in filter coefficient information #101′. The encoding section (i) sorts, in the encoding order, all the data that it has encoded and (ii) outputs the data to the outside.

The binarizing section 1152d transforms, by a method similar to that described in Embodiment 1, the filter coefficient aᵢ, supplied from the sorting section 1152a, into a symbol column including symbols each represented by a binary number of “0” or “1”. The binarizing section thus supplies the symbol column to the encoding section 1152e. The binarizing section, in the case where it receives a predicted value from the encoding section 1152e after supplying the filter coefficient aᵢ to the encoding section 1152e, (i) calculates the value of the difference between the predicted value and the filter coefficient aᵢ₋₁, (ii) transforms the difference value into a symbol column, and (iii) supplies the symbol column to the encoding section 1152e.

As described above, with use of a LAST1 flag, a filter coefficient to be last encoded among all filter coefficients as an encoding target is processed by (i) calculating a predicted value from an already decoded filter coefficient and (ii) encoding the value of the difference between the filter coefficient and the predicted value. The moving image encoder can thus reduce the amount of encoded data by a greater degree attributed to the above arrangement.

Alternatively, the moving image encoder may (i) calculate a predicted value also for any filter coefficient other than a filter coefficient to be last encoded and (ii) encode the value of the difference between that other filter coefficient and the predicted value.

The sorting section 1152a may alternatively carry out its sorting process such that a filter coefficient at the center is placed not at the top of filter coefficient information #101′, but at the end of it.

This arrangement does not directly encode a filter coefficient at the center which filter coefficient has the largest absolute value (that is, increases a predicted value for such a filter coefficient), and consequently increases the effect of reducing the amount of encoded data which effect is achieved by encoding a difference.

The sorting section 1152a may not carry out its sorting process on the basis of the magnitude of the absolute value of a filter coefficient. The sorting section 1152a may alternatively sort filter coefficients in descending order of the eigenvalue of a basis (for example, PCA basis) corresponding to each filter coefficient. In this case, the LAST flag generating section 1152g sets the value of a LAST flag or LAST1 flag on the basis of whether the eigenvalue of a basis corresponding to a filter coefficient which eigenvalue has been supplied from the sorting section 1152a exceeds a predetermined threshold.

(Advantage of Moving Image Encoder 1′)

As described above, in the case where the value is 0 for a filter coefficient, among two-dimensionally placed filter coefficients, that is located away from the central position by a large distance (that is, a distance having a value of not less than a predetermined value), the moving image encoder 1′ can omit encoding of, among filter coefficients that have been subjected to a sorting process, the first filter coefficient that has a value of 0 and its subsequent filter coefficients.

The moving image encoder 1′ can consequently reduce the amount of encoded data for filter coefficients as compared to the case of encoding all filter coefficients.

(Moving Image Decoder)

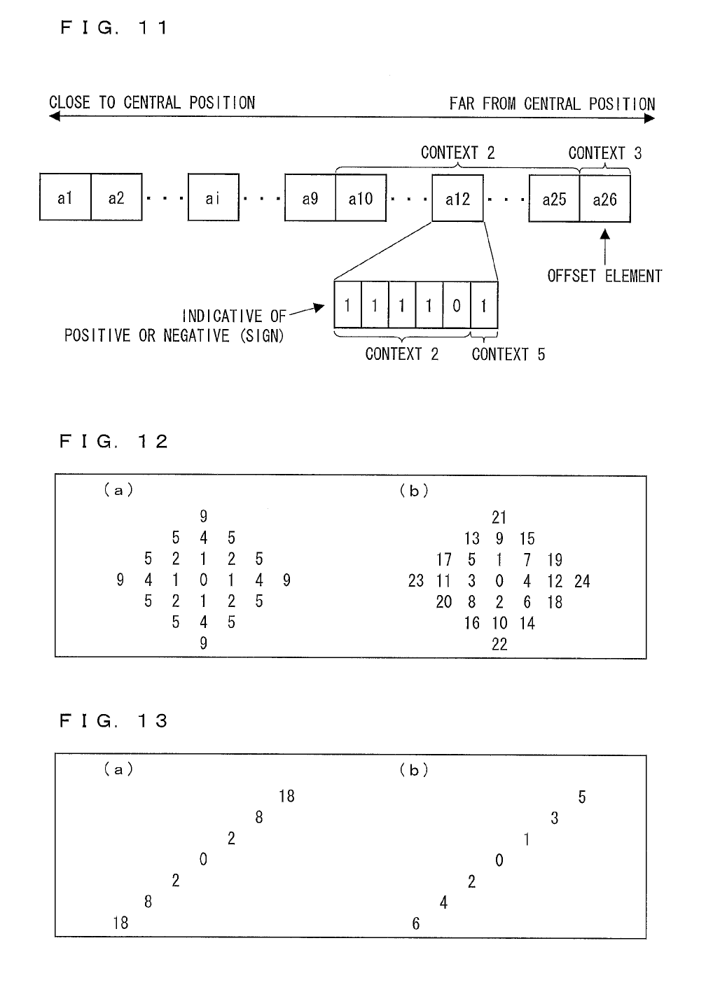

The description below deals with a moving image decoder of the present embodiment with reference to FIG. 10.

FIG. 10 is a block diagram illustrating main members of the moving image decoder.

The moving image decoder 2′ is, as in Embodiment 1, a moving image decoder that includes a part which is based on H.264/AVC standard and a technique being studied by the VCEG. The moving image decoder 2′ is characterized in that it generates an adaptive filter with reference to a LAST flag or LAST1 flag transmitted from the moving image encoder 1′.

As illustrated in FIG. 10, the moving image decoder 2′ is similar to the moving image decoder 2 in that it includes: a motion vector reconstructing section 24; a buffer memory 25; a predicted image generating section 26; an intra-predicted image generating section 27; a prediction mode determining section 28; an inverse-quantization/inverse-transformation section 29; an adder 30; and a deblocking filter 50. The moving image decoder, however, includes a variable-length-code decoding section 23′ and an adaptive filter section 100′, which decoding section 23 and the adaptive filter section 100, respectively.

The following thus deals only with the variable-length-code decoding section 23′ and the adaptive filter section 100′, and does not deal with the other members.

The variable-length-code decoding section 23′ carries out variable-length decoding with respect to encoded data #2a, and outputs a difference motion vector #23a, side information #23b, quantized prediction residual data #23c, and filter coefficient information #23d′.

The adaptive filter section 100′ carries out a filtering process with respect to a deblocked image #50.

The adaptive filter section 100′ in the present use example generates a filter on the basis of filter coefficient information #23d′ obtained through decoding of encoded data #2, and thus carries out a filtering process.

The adaptive filter section 100′ outputs, to the buffer memory 25, output image data #110a generated through the filtering process carried out with respect to the deblocked image #50.

The adaptive filter section 100′ in the present use example also substantially corresponds to an ALF (adaptive loop filter) in a KTA. In other words, the adaptive filter section 100′ of the present use example is supplied with the pixel value of an integer pixel, and outputs the pixel value of an integer pixel. This example corresponds to a case in which x, y, x′, and y′ in Formula (1) are each a value of an integer.

(Variable-Length-Code Decoding Section 23′)

The moving image decoder 2′ of the present embodiment is characterized by a decoding process carried out by a filter coefficient decoding section 2352′ included in the variable-length-code decoding section 23′.

(Arrangement of Filter Coefficient Decoding Section 2352′)

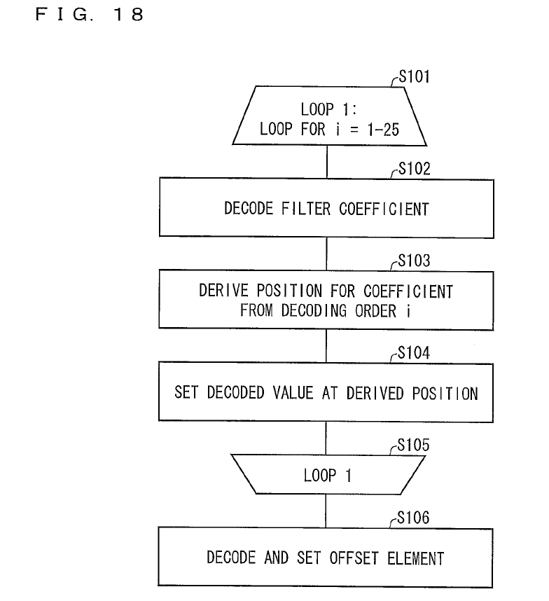

FIG. 15 is a block diagram illustrating main members of the filter coefficient decoding section 2352′.

The filter coefficient decoding section 2352, as illustrated in FIG. 15, includes: an inverse sorting section 2352a′; a context determining section 1152b; a state maintaining section 1152c; a symbol reconstructing section 2352d; a decoding section 2352e′; a state updating section 1152f; and a LAST flag decoding section 2352g. The description below does not deal with the context determining section 1152b, the state maintaining section 1152c, the state updating section 1152f, and the symbol reconstructing section 2352d, which are members that are already described above.

The LAST flag decoding section 2352g receives encoded data #2 and decodes a LAST flag or LAST1 flag.

The decoding section 2352e′ is similar to the decoding section 2352e in that it (i) decodes an arithmetic code in response to encoded data #2 and (ii) outputs, to the symbol reconstructing section 2352d, a resulting symbol column including binary numbers. The decoding section 2352e′ is different from the decoding section 2352e in that it additionally stops a decoding process in correspondence with the value of a LAST flag or LAST1 flag.

The inverse sorting section 2352a′ is similar to the inverse sorting section 2352a in that it sorts, on the basis of the order of decoding filter coefficients, the filter coefficients in an order of the filter coefficients which order is required by the adaptive filter section 100′. The inverse sorting section 2352a′ is different from the inverse sorting section 2352a in that the inverse sorting section (i), in sorting filter coefficients, does not wait for all filter coefficients to be prepared, but (ii) each time it decodes a filter coefficient, calculates a position for that filter coefficient in a filter coefficient set on the basis of the order of its decoding, and sets the filter coefficient at that position.

The filter coefficient decoding section 2352′ can, as well as the filter coefficient decoding section 2352, use Huffman coding instead of arithmetic coding. Since the use of a LAST flag and a LAST1 flag improves encoding efficiency, the filter coefficient decoding section may use a single Huffman code table in using Huffman coding. In other words, the filter coefficient decoding section is not necessarily required to switch to a different Huffman code table for use in next decoding on the basis of the value of an immediately previously decoded filter coefficient.

The filter coefficient decoding section 2352′ may, as well as the filter coefficient decoding section 2352, decode a filter coefficient encoded as a difference from a predicted value.

(Detailed Operation of Variable-Length-Code Decoding Section 23′)

With reference to FIGS. 18 through 20, the description below deals with operation of the variable-length-code decoding section 23′ for (i) a case in which encoded data includes neither a LAST flag nor a LAST1 flag, (ii) a case in which encoded data includes a LAST flag, and (iii) a case in which encoded data includes a LAST1 flag.

FIG. 18 is a diagram illustrating a flow of the operation of the variable-length-code decoding section 23′ for a case in which encoded data includes neither a LAST flag nor a LAST1 flag.

(Step S101) Loop 1: The variable-length-code decoding section carries out S102 through S105 while 1≦loop variable i (initial value=1)≦25 is satisfied.

(Step S102) The variable-length-code decoding section decodes a filter coefficient. In the case where the filter coefficient is encoded as the value of a difference from a predicted value, the variable-length-code decoding section decodes the difference value and adds the difference value to the predicted value to decode the filter coefficient.

(Step S103) The variable-length-code decoding section calculates a position for the filter coefficient from a decoding order i.

(Step S104) The variable-length-code decoding section sets the decoded filter coefficient at the calculated position for the filter coefficient in a filter coefficient set.

(Step S105) End of Loop 1: The variable-length-code decoding section determines whether the loop variable i is 25. In the case where i is not 25, the variable-length-code decoding section increases i by 1, and the operation returns to S102. In the case where the loop variable i is 25, the operation proceeds to S106.

(Step S106) The variable-length-code decoding section decodes an offset, and sets it as the value of the last component of the filter coefficient set.

The variable-length-code decoding section 23′, as described above, decodes filter coefficients as in the set M₄ of Formula (7).

$$\begin{matrix}[ Math 7 ] & \\ {M}_{4} = [ \begin{matrix}0 & 0 & 0 & - 1 & 0 & 0 & 0 \\ 0 & 0 & - 1 & 5 & - 1 & 0 & 0 \\ 0 & - 1 & 3 & - 8 & 3 & - 1 & 0 \\ - 1 & 3 & - 9 & 16 & - 9 & 4 & - 1 \\ 0 & - 1 & 4 & - 8 & 4 & - 1 & 0 \\ 0 & 0 & - 1 & 5 & - 1 & 0 & 0 \\ 0 & 0 & 0 & - 1 & 0 & 0 & 0\end{matrix} ] & ( 7 )\end{matrix}$$

As is clear from Formula (7), the filter coefficient set M₄ is identical to the filter coefficient set (that is, the filter coefficient set M₁ in Formula (1)) for a filter applied by the adaptive filter section 100 of the moving image encoder 1′.

FIG. 19 is a diagram illustrating flows of the operation of the variable-length-code decoding section 23 for a case in which encoded data includes a LAST flag. Both flows are characterized in that a filter coefficient and a LAST flag are encoded as a set. (a) of FIG. 19 illustrates a case in which encoded data is arranged such that a LAST flag is encoded after a filter coefficient, whereas (b) of FIG. 19 illustrates a case in which encoded data is arranged such that a LAST flag is encoded before a filter coefficient.

The following describes the operation flow for the case in which a LAST flag is encoded after a filter coefficient.

(Step S201) Loop 1: The variable-length-code decoding section carries out S202 through S205 while 1≦loop variable i (initial value=1)≦25 is satisfied.

(Step S202) The variable-length-code decoding section decodes a filter coefficient, and sets that decoded coefficient at a position for that filter coefficient which position is calculated from a decoding order i.

(Step S203) The variable-length-code decoding section decodes a LAST flag.

(Step S204) The variable-length-code decoding section determines whether the LAST flag is 1. In the case where the LAST flag is 1, the operation proceeds to S206. Otherwise, the operation proceeds to S205.

(Step S205) End of Loop 1: The variable-length-code decoding section determines whether the loop variable i is 25. In the case where i is not 25, the variable-length-code decoding section increases i by 1, and the operation returns to S202. In the case where the loop variable i is 25, the operation proceeds to S206.

(Step S206) The variable-length-code decoding section decodes a filter coefficient provided with no LAST flag, and sets that filter coefficient in a filter coefficient set. In this example, the variable-length-code decoding section decodes an offset, and sets it as the value of the last component of the filter coefficient set.

The following describes the operation flow for the case in which a LAST flag is encoded before a filter coefficient.

(Step S251) Loop 1: The variable-length-code decoding section carries out S252 through S254 and S256 while 1≦loop variable i (initial value=1)≦25 is satisfied.

(Step S252) The variable-length-code decoding section decodes a LAST flag.

(Step S253) The variable-length-code decoding section determines whether the LAST flag is 1. In the case where the LAST flag is 1, the operation proceeds to S255. Otherwise, the operation proceeds to S254.

(Step S254) The variable-length-code decoding section decodes a filter coefficient, and sets that decoded coefficient at a position for that filter coefficient which position is calculated from a decoding order i. The operation then proceeds to S256.

(Step S255) The variable-length-code decoding section decodes a filter coefficient, and sets the decoded coefficient at a position for the filter coefficient which position is calculated from a decoding order i. The operation then proceeds to S257.

(Step S256) End of Loop 1: The variable-length-code decoding section determines whether the loop variable i is 25. In the case where i is not 25, the variable-length-code decoding section increases i by 1, and the operation returns to S252. In the case where the loop variable i is 25, the operation proceeds to S257.

(Step S257) The variable-length-code decoding section decodes a filter coefficient provided with no LAST flag, and sets that filter coefficient in a filter coefficient set. In this example, the variable-length-code decoding section decodes an offset, and sets it as the value of the last component of the filter coefficient set.

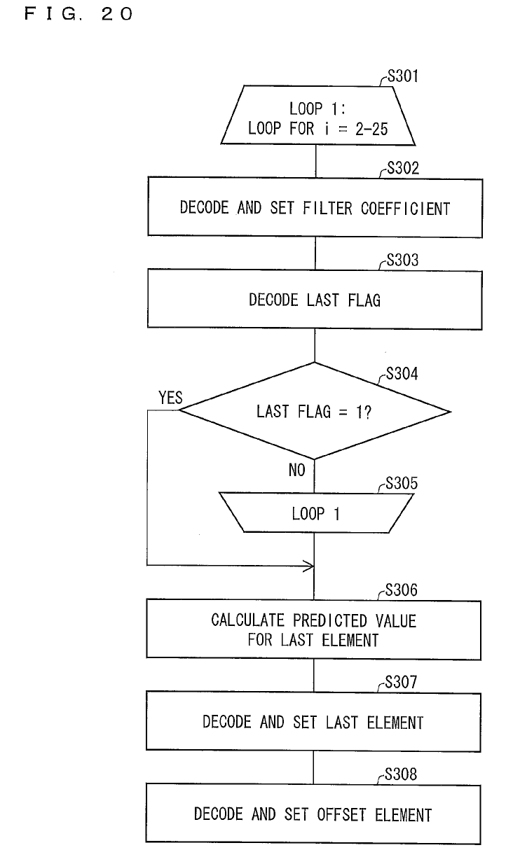

FIG. 20 is a diagram illustrating flows of the operation of the variable-length-code decoding section 23 for a case in which encoded data is arranged to include a LAST1 flag. This example illustrates a case in which encoded data is arranged such that a LAST1 flag is encoded after a filter coefficient. The variable-length-code decoding section 23 can, even in a case where a LAST1 flag is encoded after a filter coefficient, carry out its process by, as in (b) of FIG. 19, switching the order of (i) a decoding process for a filter coefficient in S302 and (ii) a process for a LAST1 flag in S303 and S304.

(Step S301) Loop 1: The variable-length-code decoding section carries out S302 through S305 while 2≦loop variable i (initial value=2)≦25 is satisfied.

(Step S302) The variable-length-code decoding section decodes a filter coefficient, and sets that decoded coefficient at a position for that filter coefficient which position is calculated from a decoding order i.

(Step S303) The variable-length-code decoding section decodes a LAST1 flag.

(Step S304) The variable-length-code decoding section determines whether the LAST flag1 is 1. In the case where the LAST flag is 1, the operation proceeds to S306. Otherwise, the operation proceeds to S305.

(Step S305) End of Loop 1: The variable-length-code decoding section determines whether the loop variable i is 25. In the case where i is not 25, the variable-length-code decoding section increases i by 1, and the operation returns to S302. In the case where the loop variable i is 25, the operation proceeds to S306.

(Step S306) The variable-length-code decoding section calculates a predicted value for the last element. The variable-length-code decoding section calculates the sum total (a₂ through aᵢ) of the already set filter coefficients, and subtracts the sum total from 1. The variable-length-code decoding section sets the resulting value as a predicted value for a filter coefficient corresponding to a decoding order 1.

(Step S307) The variable-length-code decoding section adds a difference value, obtained by decoding encoded data, to the predicted value to decode the last element. The variable-length-code decoding section thus sets that filter coefficient at a position corresponding to the decoding order 1.

(Step S308) The variable-length-code decoding section decodes a filter coefficient provided with no LAST1 flag, and sets that filter coefficient in a filter coefficient set. In this example, the variable-length-code decoding section decodes an offset, and sets it as the value of the last component of the filter coefficient set.

Finally, the variable-length-code decoding section sets, to “0”, the value of any component for which no value is set.

The variable-length-code decoding section 23′, as described above, decodes filter coefficients as in the set M₅ of Formula (8).

$$\begin{matrix}[ Math 8 ] & \\ {M}_{5} = [ \begin{matrix}0 & 0 & 0 & 0 & 0 & 0 & 0 \\ 0 & 0 & 0 & 5 & 0 & 0 & 0 \\ 0 & 0 & 3 & - 8 & 3 & 0 & 0 \\ 0 & 3 & - 9 & 16 & - 9 & - 8 & 0 \\ 0 & 0 & 4 & - 8 & 4 & 0 & 0 \\ 0 & 0 & 0 & 5 & 0 & 0 & 0 \\ 0 & 0 & 0 & 0 & 0 & 0 & 0\end{matrix} ] & ( 8 )\end{matrix}$$

Thus, even with use of a LAST1 flag, the adaptive filter section 100′ applies a filter having a characteristic that is identical to that of a filter applied by the adaptive filter section 100 of the moving image encoder 1′.

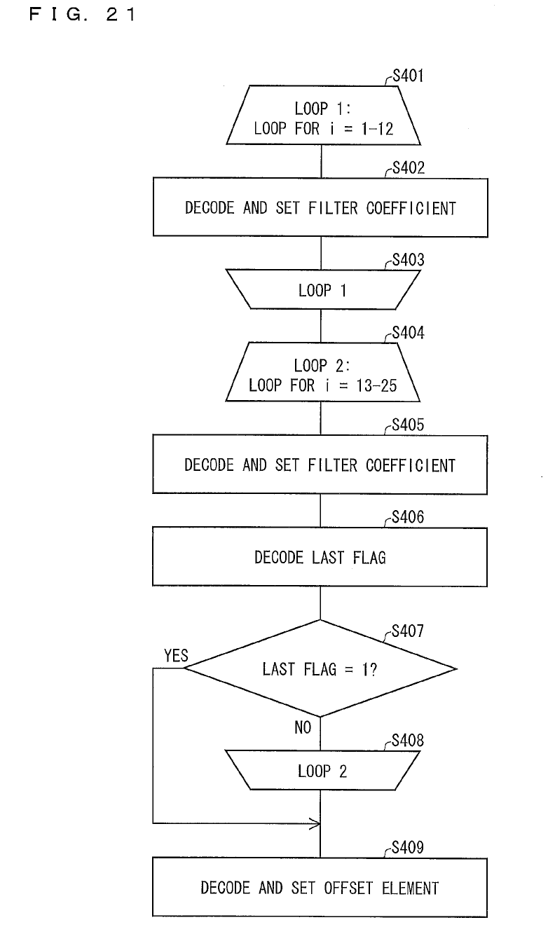

FIG. 21 is a diagram illustrating a flow of the operation of the variable-length-code decoding section 23 for a case in which encoded data is arranged to include a LAST flag for a filter coefficient placed at or subsequently to a predetermined position in the decoding order. The following describes an operation for a case in which encoded data is such data as illustrated in FIG. 16.

(Step S401) Loop 1: The variable-length-code decoding section carries out S402 and S403 while 1≦loop variable i (initial value=1)≦12 is satisfied.

(Step S402) The variable-length-code decoding section decodes a filter coefficient, and sets that decoded coefficient at a position for that filter coefficient which position is calculated from a decoding order i.

(Step S403) End of Loop 1: The variable-length-code decoding section determines whether the loop variable i is 12. In the case where i is not 12, the variable-length-code decoding section increases i by 1, and the operation returns to

S402. In the case where the loop variable i is 12, the variable-length-code decoding section increases i by 1, and the operation proceeds to S404.

(Step S404) Loop 2: The variable-length-code decoding section carries out S405 through S408 while 13≦loop variable i≦25 is satisfied.

(Step S405) The variable-length-code decoding section decodes a filter coefficient, and sets that decoded coefficient at a position for that filter coefficient which position is calculated from a decoding order i.

(Step S406) The variable-length-code decoding section decodes a LAST flag.

(Step S407) The variable-length-code decoding section determines whether the LAST flag is 1. In the case where the LAST flag is 1, the operation proceeds to S409. Otherwise, the operation proceeds to S408.

(Step S408) End of Loop 2: The variable-length-code decoding section determines whether the loop variable i is 25. In the case where i is not 25, the variable-length-code decoding section increases i by 1, and the operation returns to S405. In the case where the loop variable i is 25, the operation proceeds to S409.

(Step S409) The variable-length-code decoding section decodes a filter coefficient provided with no LAST flag, and sets that filter coefficient in a filter coefficient set. In this example, the variable-length-code decoding section decodes an offset, and sets it as the value of the last component of the filter coefficient set.

Finally, the variable-length-code decoding section sets, to “0”, the value of any component for which no value is set.

The variable-length-code decoding section 23′ can, even in a case where a LAST flag is encoded after a filter coefficient, carry out a decoding process by, as in (b) of FIG. 19, switching the order of (i) a decoding process for a filter coefficient in S405 and (ii) a process for a LAST1 flag in S406 and S407.

The variable-length-code decoding section 23′ can, by carrying out an operation that (i) replaces “LAST flag” in S406 and S407 in the flowchart of FIG. 21 with “LAST1 flag” and (ii) follows a flowchart that additionally includes S306 and S307 of FIG. 20 before S409, carry out a decoding process with respect to even data encoded with use of a LAST1 flag.

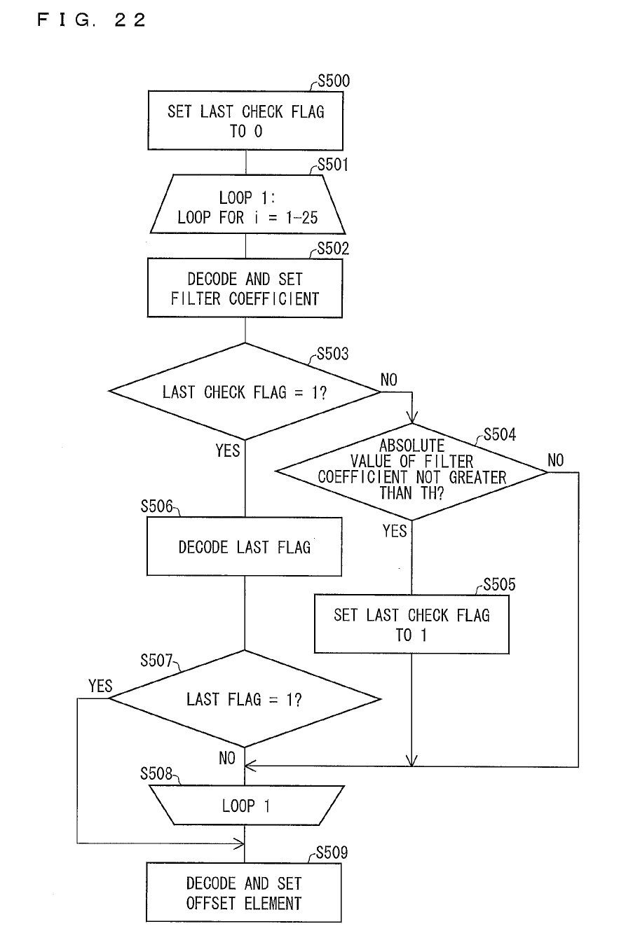

FIG. 22 is a diagram illustrating a flow of the operation of the variable-length-code decoding section 23′ for a case in which encoded data includes a LAST flag for a filter coefficient placed subsequently to the first filter coefficient that has an absolute value which is not greater than a predetermined constant TH. The following describes an operation for a case in which encoded data is such data as illustrated in FIG. 17.

(Step S500) The variable-length-code decoding section sets a LAST check flag to 0.

(Step S501) Loop 1: The variable-length-code decoding section carries out S502 through S508 while 1≦loop variable i (initial value=1) 25 is satisfied.

(Step S502) The variable-length-code decoding section decodes a filter coefficient, and sets that decoded coefficient at a position for that filter coefficient which position is calculated from a decoding order i.

(Step S503) The variable-length-code decoding section determines whether the LAST check flag is 1. In the case where the LAST check flag is 1, the operation proceeds to S506. Otherwise, the operation proceeds to S504.

(Step S504) The variable-length-code decoding section determines whether the filter coefficient has an absolute value that is not greater than a predetermined threshold TH. In the case where the absolute value is not greater than the predetermined threshold, the operation proceeds to S505. Otherwise, the operation proceeds to S508.

(Step S505) The variable-length-code decoding section sets a LAST check flag to 1.

(Step S506) The variable-length-code decoding section decodes a LAST flag.

(Step S507) The variable-length-code decoding section determines whether the LAST flag is 1. In the case where the LAST flag is 1, the operation proceeds to S509. Otherwise, the operation proceeds to S508.

(Step S508) End of Loop 2: The variable-length-code decoding section determines whether the loop variable i is 25. In the case where i is not 25, the variable-length-code decoding section increases i by 1, and the operation returns to S502. In the case where the loop variable i is 25, the operation proceeds to S509.

(Step S509) The variable-length-code decoding section decodes a filter coefficient provided with no LAST flag, and sets that filter coefficient in a filter coefficient set. In this example, the variable-length-code decoding section decodes an offset, and sets it as the last component of the filter coefficient set.

Finally, the variable-length-code decoding section sets, to “0”, the value of any component for which no value is set.

The variable-length-code decoding section 23′ can, even in a case where a LAST flag is encoded after a filter coefficient, carry out a decoding process by, as in (b) of FIG. 19, switching the order of (i) decoding of a filter coefficient in S505 and (ii) a process for a LAST1 flag in S506 and S507.

The variable-length-code decoding section 23′ can, by (i) replacing “LAST flag” with “LAST1 flag” and (ii) adding S306 and S307 before S509, carry out a decoding process with respect to even data encoded with use of a LAST1 flag.

(Advantage of Moving Image Decoder 2′)

With the above arrangement, the moving image decoder 2′ can, by referring to a LAST flag or LAST1 flag, generate a decoded image without (i) causing an influence on an image to be decoded and (ii) carrying out a decoding process with respect to all filter coefficients.

(Supplemental Notes)

The embodiments above each describe an encoding process to be carried out with respect to filter coefficients for a filter used by an adaptive filter section 100 (ALF). The present invention can also be applied similarly to an encoding process to be carried out with respect to filter coefficients for a filter used by an adaptive interpolation filter (AIF). The encoding process of the present invention for filter coefficients can be carried out with respect to, not only an AIF and an ALF, but also any filter including filter coefficients for use in a filtering process that are characterized such that an element close to the central position has an absolute value which is larger (or smaller) than that of an element far from the central position.

The encoding section 1152e of Embodiment 1 may be arranged such that a context for use in arithmetic coding of a filter coefficient (the closest filter coefficient (a filter coefficient placed in the vicinity of δ=0 from the central position; there may be two or more thereof)) in a filter coefficient set included in a filter for use by the adaptive filter section 100 which filter coefficient is closest to the central position is a context different from a context for use in arithmetic coding of the other filter coefficients. The encoding section may also be arranged to use separate contexts for the closest filter coefficient and for the other filter coefficients and to additionally use, for the other filter coefficients, (i) a context for a filter coefficient for which the distance d (where d=|k−i|+|1−j|; the central position is (i,j), and the position of each element is (k,1)) from the central position is 1 or 2 and (ii) a context for a filter coefficient for which the distance from the central position is 3 or greater. This is because the adaptive filter section 100 (ALF) uses a filter that is typically characterized by a strong tendency in which a filter coefficient having a distance d of 1 or 2 from the central position is larger than a filter coefficient having a distance d of 3 or greater from the central position.

The encoding section 1152e may alternatively carry out fixed-length encoding with respect to only the closest filter coefficient. Further, as in Embodiment 2, the encoding section 1152e may, instead of encoding the closest filter coefficient, encode the value of a difference between (i) a predicted value obtained by subtracting from 1 the sum total of the other filter coefficients and (ii) the filter coefficient at the central position.

The embodiments described above may each be arranged to control a moving image encoder or moving image decoder by (i) recording on a computer-readable recording medium a program for carrying out each function of the moving image encoder or moving image decoder, (ii) causing a computer system to read the program recorded on the recording medium, and (iii) executing the program. The term “computer system” as used herein includes in scope an OS and hardware such as a peripheral device.

The term “computer-readable recording medium” as used herein refers to (i) a transportable medium such as a flexible disk, a magneto-optical disk, a ROM, and a CD-ROM and (ii) a memory device such as a hard disk built in a computer system. The “computer-readable recording medium” further includes (i) a medium that dynamically stores a program for a short period of time, such as a communication line for use in transmission of a program over a communications line such as a network (for example, the Internet) and a telephone line and (ii) a medium that stores a program for a certain period of time, such as a volatile memory inside a computer system serving as a server or client for the case (i) above. The program may carry out a part of the functions described above, or may carry out the above functions in combination with a program already recorded in a computer system.

As described above, the encoder of the present invention may preferably be arranged such that the encoding means carries out arithmetic coding of the at least a part of filter coefficients in the filter coefficient set in correspondence with respective occurrence probabilities of individual symbols in a symbol column corresponding to an already encoded filter coefficient.

According to the above arrangement, the encoder, with high frequency, (i) generates a symbol column including, in ascending or descending order of absolute value of filter coefficients, prescribed symbols in a number corresponding to the absolute value of each filter coefficient and (ii) carries out arithmetic coding of the symbol column thus generated. This indicates that the number of prescribed symbols included in a symbol column of which the encoder carries out arithmetic coding tends to gradually decrease or increase through the process of arithmetic coding of individual filter coefficients. The encoder carries out arithmetic coding in correspondence with respective probabilities of occurrence of symbols in an already arithmetically coded symbol column.

The encoder of the present invention thus, as compared to a conventional encoder that reads out individual filter coefficients in a filter matrix by raster-scanning and carries out arithmetic coding thereof, allows the respective probabilities of occurrence of prescribed symbols, which probabilities are applied during arithmetic coding, to be close to actual probabilities of occurrence of prescribed symbols.

The encoder may preferably be arranged such that the encoding means carries out arithmetic coding of, among a plurality of filter coefficients for which the distance from the central position of the two-dimensional filter is equal, a filter coefficient preferentially over other filter coefficients which is located at a position in the two-dimensional filter which position is closest, among the plurality of filter coefficients, to a position of a filter coefficient that the encoding means last encoded.

A two-dimensional filter for use as an adaptive interpolation filter or an adaptive loop filter has a tendency in which filter coefficients placed in the vicinity of each other have respective values that are close to each other.

The above arrangement thus provides a stronger tendency in which the number of prescribed symbols included in a symbol column of which the encoder carries out arithmetic coding gradually increases or decreases through the process of arithmetic coding of individual filter coefficients. This allows the respective probabilities of occurrence of prescribed symbols, which probabilities are applied during arithmetic coding, to be closer to actual probabilities of occurrence of prescribed symbols. The encoder can thus, with the above arrangement, achieve a further advantage of more effectively reducing the amount of encoded data for filter coefficients to be transmitted to a decoder.

The encoder may desirably be arranged such that the encoding means carries out arithmetic coding of the at least a part of filter coefficients on a basis of a plurality of contexts, the encoding means carrying out arithmetic coding of (i) a filter coefficient at the central position of the two-dimensional filter on a basis of a first context and (ii) other filter coefficients on a basis of a second context different from the first context.

The encoder may desirably be arranged such that the encoding means carries out arithmetic coding of the at least a part of filter coefficients on a basis of a plurality of contexts, the encoding means carrying out arithmetic coding of (i) on a basis of a first context, a filter coefficient for which the distance from the central position of the two-dimensional filter is 2 or less and (ii) on a basis of a second context different from the first context, a filter coefficient for which the distance from the central position of the two-dimensional filter is 3 or greater.

The encoder of the present invention may be arranged such that the encoding means carries out Huffman coding of the at least a part of filter coefficients in the filter coefficient set with reference to a Huffman code table corresponding to an already encoded filter coefficient.

The above arrangement also sequentially encodes filter coefficients sorted in either ascending or descending order of absolute value. The above arrangement can thus achieve the advantage of reducing the amount of encoded data as compared to a case of sequentially encoding filter coefficients arranged in a predetermined order (for example, a raster scan order).

The decoder may desirably be arranged such that the decoding means carries out arithmetic decoding of the at least a part of filter coefficients in the filter coefficient set in correspondence with respective occurrence probabilities of individual symbols in a symbol column corresponding to an already decoded filter coefficient.

The above arrangement can, in the case where encoded data obtained by the encoder is encoded data obtained by arithmetic coding, decode a filter coefficient set arranged in a predetermined order (for example, a raster scan order).

The decoder may desirably be arranged such that the decoding means carries out Huffman coding of the at least a part of filter coefficients in the filter coefficient set with decoded filter coefficient.

The above arrangement can, in the case where encoded data obtained by the encoder is encoded data obtained by Huffman coding, decode a filter coefficient set arranged in a predetermined order (for example, a raster scan order).

The present invention includes in its scope a data structure of encoded data generated by the above encoder.

The present invention is not limited to the description of the embodiments above, but may be altered in various ways by a skilled person within the scope of the claims. Any embodiment based on a proper combination of technical means disclosed in different embodiments is also encompassed in the technical scope of the present invention.

### INDUSTRIAL APPLICABILITY

The present invention is suitably applicable to (i) a moving image encoder that encodes an adaptive image filter for carrying out a filtering process with respect to moving image data and (ii) a decoder that decodes moving image data encoded by such a moving image encoder.

### REFERENCE SIGNS LIST

1, 1′ moving image encoder (encoder)
2, 2′ moving image decoder (decoder)
100 adaptive filter section
100′ adaptive filter section
12, 12′ variable-length coding section
1152 filter coefficient encoding section
1152a sorting section (sorting means)
1152e encoding section (encoding means)
1152′ filter coefficient encoding section
23 variable-length-code decoding section (decoding means)
2352 filter coefficient decoding section
2352a inverse sorting section (inverse sorting means)
2352e decoding section (decoding means)

1-11. (canceled)

12. A decoder for carrying out a decoding process with respect to encoded data,
the decoder comprising:
decoding means for decoding, from each bit sequence included in the encoded data, a corresponding integer value on a basis of a correspondence between (i) an integer value defined for each state value and obtained during the decoding process and (ii) a bit sequence contained in the encoded data;
updating means for updating the state value on a basis of an integer value immediately previously decoded by the decoding means from a bit sequence; and
selecting means for selecting, (i) from among a plurality of defined correspondences and (ii) on a basis of the state value as updated by the updating means, a correspondence to be referred to during the decoding process for a first bit sequence as a subsequent decoding target,
the decoding means being arranged to decode, from the first bit sequence, an integer value corresponding to the first bit sequence in accordance with the correspondence selected by the selecting means.

13. The decoder according to claim 12,
wherein:
the correspondence on the basis of which the decoding means carries out the decoding is a correspondence defined with reference to a Huffman code table.

14. The decoder according to claim 12,
wherein:
the correspondence on the basis of which the decoding means carries out the decoding is a correspondence defined with reference to a Golomb code table.

15. The decoder according to claim 12,
wherein:
the decoding means is arranged to decode, from compression-encoded data, a filter coefficient set including at least a part of filter coefficients included in a two-dimensional filter for use as an adaptive interpolation filter or an adaptive loop filter; and
the decoding means is arranged to be capable of decoding the at least a part of filter coefficients in the filter coefficient set from the encoded data for each symbol.

16. The decoder according to claim 15, further comprising:
inverse sorting means for sorting, in a predetermined order, a filter coefficient set that is obtained by the decoding means and that is arranged in correspondence with a distance from a central position of the two-dimensional filter.

17. An encoder for preparing encoded data by encoding an integer value for each encoding target,
the encoder comprising:
encoding means for preparing the encoded data by encoding each integer value into a corresponding bit sequence on a basis of a correspondence between (i) an integer value defined for each state value and (ii) a bit sequence contained in the encoded data;
updating means for updating the state value on a basis of an integer value for which the encoding means immediately previously carried out an encoding process; and
selecting means for selecting, (i) from among a plurality of defined correspondences and (ii) on a basis of the state value as updated by the updating means, a correspondence to be referred to during the encoding process for a first integer value as a subsequent encoding target,
the encoding means being arranged to encode the first integer value into a bit sequence corresponding to the first integer value in accordance with the correspondence selected by the selecting means.

18. The encoder according to claim 17,
wherein:
the correspondence on the basis of which the encoding means carries out the encoding is a correspondence defined with reference to a Huffman code table.

19. The encoder according to claim 17,
wherein:
the correspondence on the basis of which the encoding means carries out the encoding is a correspondence defined with reference to a Golomb code table.

20. The encoder according to claim 17,
wherein:
the encoding means is arranged to encode a filter coefficient set including at least a part of filter coefficients included in a two-dimensional filter for use as an adaptive interpolation filter or an adaptive loop filter; and
the encoding means is arranged to be capable of encoding the at least a part of filter coefficients in the filter coefficient set for each symbol.

21. The encoder according to claim 20, further comprising:
sorting means for sorting, in an order corresponding to a distance from a central position of the two-dimensional filter, the filter coefficient set arranged in a predetermined order,
wherein:
the encoding means is arranged to encode the at least a part of filter coefficients in the filter coefficient set sequentially from a filter coefficient most preceding in the order as sorted.
